(19) United States
(12) Patent Application Publication
(10) Pub. No.: US 2024/0311103 A1
(43) Pub. Date: Sep. 19, 2024

(54) SPLIT-COMPUTE COMPILER AND GAME ENGINE

(71) Applicant: QUALCOMM Incorporated, San Diego, CA (US)

(72) Inventors: Nikolai Konrad LEUNG, San Francisco, CA (US); Bojan VRCELJ, San Diego, CA (US); Imed BOUAZIZI, Frisco, TX (US)

(21) Appl. No.: 18/428,673

(22) Filed: Jan. 31, 2024

Related U.S. Application Data
(60) Provisional application No. 63/490,755, filed on Mar. 16, 2023.

(51) Int. Cl. G06F 8/41; G06T 1/20; H04W 24/02

(52) U.S. Cl. CPC G06F 8/41; G06T 1/20; H04W 24/02

(57) ABSTRACT

This disclosure provides systems, devices, apparatus, and methods, including computer programs encoded on storage media, for a split-compute compiler and game engine. A processor may obtain an executable for an application including a first set of application functions associated with the UE and a second set of application functions associated with a computing device that is different from the UE. The processor may obtain an estimated quality of a link between the UE and the computing device. The processor may obtain, based on the estimated quality of the link, a split-compute configuration between the first set of application functions and the second set of application functions. The processor may output an indication of the split-compute configuration.

### CROSS REFERENCE TO RELATED APPLICATION(S)

This application claims the benefit of U.S. Provisional Application Ser. No. 63/490,755, entitled “SPLIT-COMPUTE COMPILER AND GAME ENGINE” and filed on Mar. 16, 2023, which is expressly incorporated by reference herein in its entirety.

### TECHNICAL FIELD

The present disclosure relates generally to processing systems, and more particularly, to one or more techniques for graphics processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor may be configured to convert digital information received from a CPU to analog values and may issue commands to a display panel for displaying the visual content. A device that provides content for visual presentation on a display may utilize a CPU, a GPU, and/or a display processor.

Current techniques pertaining to split-compute may not address fluctuations in a quality of a link between a device and an edge. Furthermore, current techniques pertaining to application development may not address split-compute. There is a need for improved techniques pertaining to split-compute and application development.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus at a user equipment (UE) are provided. The apparatus includes a memory; and a processor coupled to the memory and, based on information stored in the memory, the processor is configured to: obtain an executable for an application including a first set of application functions associated with the UE and a second set of application functions associated with a computing device that is different from the UE; obtain an estimated quality of a link between the UE and the computing device; obtain, based on the estimated quality of the link, a split-compute configuration between the first set of application functions and the second set of application functions; and output an indication of the split-compute configuration.

In an aspect of the disclosure, a method, a computer-readable medium, and an apparatus at a server are provided. The apparatus includes a memory; and a processor coupled to the memory and, based on information stored in the memory, the processor is configured to: obtain an executable for an application including a first set of application functions associated with a user equipment (UE) and a second set of application functions associated with the server; obtain an estimated quality of a link between the UE and the server; obtain, based on the estimated quality of the link, a split-compute configuration between the first set of application functions and the second set of application functions; and output an indication of the split-compute configuration.

In an aspect of the disclosure, a method, a computer-readable medium, and an apparatus are provided. The apparatus includes a memory; and a processor coupled to the memory and, based on information stored in the memory, the processor is configured to: obtain source code for an application; decompose the source code into a first set of application functions associated with a user equipment (UE) and a second set of application functions associated with a computing device that is different from the UE, where at least one of the first set of application functions or the second set of application functions are associated with a quality of a link between the UE and the computing device; generate a first executable for the UE based on the first set of application functions and a second executable for the computing device based on the second set of application functions; and provide the first executable for the UE and the second executable for the at least one server.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram that illustrates an example content generation system in accordance with one or more techniques of this disclosure.

FIG. 2 illustrates an example GPU in accordance with one or more techniques of this disclosure.

FIG. 3 illustrates an example image or surface in accordance with one or more techniques of this disclosure.

FIG. 4 is a diagram illustrating an example of a wireless communications system and an access network in accordance with one or more techniques of this disclosure.

FIG. 5A is a diagram illustrating an example of a first frame, in accordance with one or more techniques of this disclosure.

FIG. 5B is a diagram illustrating an example of downlink (DL) channels within a subframe, in accordance with one or more techniques of this disclosure.

FIG. 5C is a diagram illustrating an example of a second frame, in accordance with one or more techniques of this disclosure.

FIG. 5D is a diagram illustrating an example of uplink (UL) channels within a subframe, in accordance with one or more techniques of this disclosure.

FIG. 6 is a diagram illustrating an example of a base station and user equipment (UE) in an access network in accordance with one or more techniques of this disclosure.

FIG. 7 is a diagram illustrating development processes for a personal computer (PC) executable and a mobile executable for an application in accordance with one or more techniques of this disclosure.

FIG. 8 is a diagram illustrating an example UE-Edge split-compute Spectrum in accordance with one or more techniques of this disclosure.

FIG. 9 is a diagram illustrating examples of split-compute strategies in accordance with one or more techniques of this disclosure.

FIG. 10 is a diagram illustrating an example of operating points of split-compute in accordance with one or more techniques of this disclosure.

FIG. 11 is a diagram illustrating an example of shifting extended reality (XR) media processing between an edge and a UE in accordance with one or more techniques of this disclosure

FIG. 12 is a diagram illustrating another example of shifting XR media processing between an edge and a UE in accordance with one or more techniques of this disclosure.

FIG. 13 is a diagram illustrating an example of predicting a millimeter wave (mmW) blockage while an XR application is executing in accordance with one or more techniques of this disclosure.

FIG. 14 is a diagram illustrating an example of a split-compute compiler that generates a device executable and an edge executable in accordance with one or more techniques of this disclosure.

FIG. 15 is a diagram illustrating an example of a developer computing device that includes a split-compute compiler in accordance with one or more techniques of this disclosure.

FIG. 16 is a diagram illustrating an example of a shared game state between an edge and a UE in accordance with one or more techniques of this disclosure.

FIG. 17 is a diagram illustrating examples of a device, a server, and a central application server in accordance with one or more techniques of this disclosure.

FIG. 18 is a diagram illustrating an example of a UE application shared game state in accordance with one or more techniques of this disclosure.

FIG. 19 is a diagram illustrating example aspects of adaptive rate control and adaptive split plus rate control in accordance with one or more techniques of this disclosure.

FIG. 20 is a call flow diagram illustrating example communications between a developer computing device, a UE, and a server in accordance with one or more techniques of this disclosure.

FIG. 21 is a call flow diagram illustrating further example communications between a developer computing device, a UE, and a server in accordance with one or more techniques of this disclosure.

FIG. 22 is a flowchart of an example method of graphics processing in accordance with one or more techniques of this disclosure.

FIG. 23A is a flowchart of an example method of graphics processing in accordance with one or more techniques of this disclosure.

FIG. 23B is a flowchart of an example method of graphics processing in accordance with one or more techniques of this disclosure.

FIG. 23C is a flowchart of an example method of graphics processing in accordance with one or more techniques of this disclosure.

FIG. 24 is a flowchart of an example method of graphics processing in accordance with one or more techniques of this disclosure.

FIG. 25A is a flowchart of an example method of graphics processing in accordance with one or more techniques of this disclosure.

FIG. 25B is a flowchart of an example method of graphics processing in accordance with one or more techniques of this disclosure.

FIG. 26 is a flowchart of an example method of graphics processing in accordance with one or more techniques of this disclosure.

FIG. 27 is a flowchart of an example method of graphics processing in accordance with one or more techniques of this disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, processing systems, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOCs), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

The term application may refer to software. As described herein, one or more techniques may refer to an application (e.g., software) being configured to perform one or more functions. In such examples, the application may be stored in a memory (e.g., on-chip memory of a processor, system memory, or any other memory). Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

In one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As used herein, instances of the term “content” may refer to “graphical content,” an “image,” etc., regardless of whether the terms are used as an adjective, noun, or other parts of speech. In some examples, the term “graphical content,” as used herein, may refer to a content produced by one or more processes of a graphics processing pipeline. In further examples, the term “graphical content,” as used herein, may refer to a content produced by a processing unit configured to perform graphics processing. In still further examples, as used herein, the term “graphical content” may refer to a content produced by a graphics processing unit.

Different computing devices may have different hardware and hence different computing capabilities. For example, a mobile device (e.g., a phone) may include a first type of a graphics processor and a personal computer (e.g., a desktop computer) may include a second type of graphics processor, where performance attribute(s) of the second type of graphics processor are greater than performance attribute(s) of the first type of graphics processor. For instance, the second type of graphics processor may have a higher clock rate and/or a greater amount of memory in comparison to the first type of graphics processor. An application developer may develop two versions of an application (e.g., a game) to run on the mobile device and the PC, respectively. In some situations, an application developer may have insufficient resources to code and support two versions of the application. In other situations, the application developer may code and support two versions of the application; however, coding and supporting two versions of the application may utilize a relatively large amount of computing resources and/or developer time in comparison to coding and supporting a single version of the application.

Additionally, split-compute refer to a paradigm that enables an application executing on a mobile device (e.g., a UE) to provide the same (or similar experience) to a user as when the application executes on a PC while conserving power consumption of the mobile device via data and/or communications exchanged between the mobile device and an edge (which may also be referred to as a node, a compute node, a server, the cloud, etc.) over link(s). In an example, the link(s) may be or include wireless local area network (WLAN) links or 5G new radio (NR) links. Current compilers may not address issues associated with split-compute.

Various technologies pertaining to a split-compute compiler and game engine are described herein. In an example, an apparatus (e.g., a developer computing device) obtains source code for an application. The apparatus decomposes the source code into a first set of application functions associated with a UE and a second set of application functions associated with a computing device (e.g., at least one server) that is different from the UE, where at least one of the first set of application functions or the second set of application functions are associated with a quality of a link between the UE and the computing device. The apparatus generates a first executable for the UE based on the first set of application functions and a second executable for the computing device based on the second set of application functions. The apparatus provides the first executable for the UE and the second executable for the computing device. In a further example, the UE obtains an executable (e.g., the first executable) for an application including a first set of application functions associated with the UE and a second set of application functions associated with computing device that is different from the UE. The UE obtains an estimated quality of link between the UE and the computing device. The UE obtains, based on the estimated quality of the link, a split-compute configuration between the first set of application functions and the second set of application functions. The UE outputs an indication of the split-compute configuration.

Vis-a-vis decomposing the source code into the first set of application functions associated with the UE and the second set of application functions associated with the at least one server, the apparatus may enable an application to be written once for a variety of platforms, which may save developer computing resources and time. Furthermore, by obtaining an estimated quality of a link between the UE and the computing device (e.g., at least one server) and obtaining a split-compute configuration based on the estimated quality of the link, the UE may be able to provide a flexible, consistent application experience to a user of the UE while conserving battery power of the UE. Additionally, in some aspects, the split-compute configuration may enable the UE to remain in primary control of the application and the UE may orchestrate the server for assistance with computationally intensive tasks. Thus, in the event that a quality of the link between the UE and the server degrades, the UE may be able to continue providing an experience of the application to the user without interrupting execution of the application.

Split-compute may enable mobile users to have the same gaming experience as personal computer (PC) users while conserving battery by offloading part of the rendering load to the edge. However, a split-compute load may adapt to link quality changes to continue to balance saving power with providing a consistent user experience. This optimization may be difficult to balance at the application development stage as it may be connection and processor dependent. Relying on application developers to do this load-balancing may be difficult as it may be difficult for each application developer do load-balancing for each application developed. In one aspect described herein, a game engine may be run at the edge and on the UE. A UE application and an edge application may maintain a highly synched application/game state. The UE application may have logic to switch between local rendering or displaying remote rendered views so that the UE application may maintain a continued user experience, even when losing connectivity with the edge. The UE may choose a split-compute load based on an estimate of link quality. In order to give the UE different split-compute load configurations to choose from during operation of the application, a split-compiler may be used to produce UE and application builds that interoperate with each other in different matched configurations. The edge may also monitor whether packets are arriving late or with errors and signal the UE to adapt (e.g., use lower encoding rate or select a different split-compute configuration). When there are communications with a central application server, the central application server, orchestrated by the UE, may distribute compute loads and their associated media to both the UE and edge, and the edge may also compute based on information from the central server (e.g., when the link is suitable or to render information from other UEs/users).

The examples describe herein may refer to a use and functionality of a graphics processing unit (GPU). As used herein, a GPU can be any type of graphics processor, and a graphics processor can be any type of processor that is designed or configured to process graphics content. For example, a graphics processor or GPU can be a specialized electronic circuit that is designed for processing graphics content. As an additional example, a graphics processor or GPU can be a general purpose processor that is configured to process graphics content.

The terms “UE,” “device,” and “client” may be utilized interchangeably herein. Furthermore, the terms “edge,” “node (s),” “compute node(s),” “cloud,” and “server(s)” may be utilized interchangeably.

The term “extended reality” (XR) may refer to a technology that blends aspects of a digital experience and the real world. XR may include augmented reality (AR), mixed reality (MR), and/or virtual reality (VR). In AR, AR objects may be superimposed on a real-world environment as perceived through the display device. In an example, AR content may be experienced through AR glasses that include a transparent or semi-transparent surface. An AR object may be projected onto the transparent or semi-transparent surface of the glasses as a user views an environment through the glasses. In general, the AR object may not be present in the real world and the user may not interact with the AR object. In MR, MR objects may be superimposed on areal-world environment as perceived through the display device and the user may interact with the MR objects. In some aspects, MR objects may include “video see through” with virtual content added. In an example, the user may “touch” a MR object being displayed to the user (i.e., the user may place a hand at a location in the real world where the MR object appears to be located from the perspective of the user), and the MR object may “move” based on the MR object being touched (i.e., a location of the MR object on a display may change). In general, MR content may be experienced through MR glasses (similar to AR glasses) worn by the user or through a head mounted display (HMD) worn by the user. The HMD may include a camera and one or more display panels. The HMD may capture an image of environment as perceived through the camera and display the image of the environment to the user with MR objects overlaid thereon. Unlike the transparent or semi-transparent surface of the AR/MR glasses, the one or more display panels of the HMD may not be transparent or semi-transparent. In VR, a user may experience a fully-immersive digital environment in which the real-world is blocked out. VR content may be experienced through a HMD. An XR headset may be a UE, a device, or a client.

As used herein, the term “game engine” may refer to a software framework designed for the development of video games. A game engine may include libraries and support programs. A game engine may include a rendering engine for two-dimensional (2D) or three-dimensional (3D) graphics, a physics engine, collision detection and response, sound, scripting, animation, artificial intelligence, networking, streamlining, memory management, threading, localization support, a scene graph, and/or video support for cinematics.

As used herein, the term “executable” may refer to code that has been compiled into software or list of instructions that can be directly run/executed on a processor without further need for interpretation. As used herein, the term “application functions” may refer to operations that are performed by the application to provide an intended service, including rendering media, processing user input, sensing the environment, computations and calculations, etc. As used herein, the term “estimated quality of link(s)” may refer to measuring characteristics of a communication link and/or a surrounding environment to determine what data rate, latency, and/or error rates can be supported by the communications link now and potentially predict what data rate, latency, and/or error rates can be supported the communication link in the future. As used herein, the term “split-compute configuration” may refer to a particular partitioning of the functions needed by an application across more than one processors or compute hosts, e.g., rendering of compute-intensive graphics on a processor that does not rely on battery power or is not housed in a small form factor with limited heat dissipation. As used herein, the term “source code” may refer to instructions from the programmer/application developer for how an application is expected to operate.

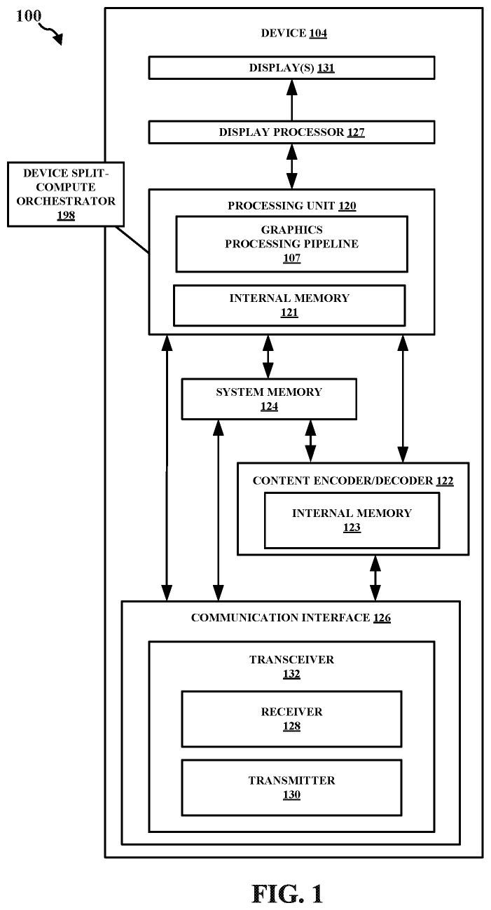

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of a SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components (e.g., a communication interface 126, a transceiver 132, a receiver 128, a transmitter 130, a display processor 127, and one or more displays 131). Display(s) 131 may refer to one or more displays 131. For example, the display 131 may include a single display or multiple displays, which may include a first display and a second display. The first display may be a left-eye display and the second display may be a right-eye display. In some examples, the first display and the second display may receive different frames for presentment thereon. In other examples, the first and second display may receive the same frames for presentment thereon. In further examples, the results of the graphics processing may not be displayed on the device, e.g., the first display and the second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing using a graphics processing pipeline 107. The content encoder/decoder 122 may include an internal memory 123. In some examples, the device 104 may include a processor, which may be configured to perform one or more display processing techniques on one or more frames generated by the processing unit 120 before the frames are displayed by the one or more displays 131. While the processor in the example content generation system 100 is configured as a display processor 127, it should be understood that the display processor 127 is one example of the processor and that other types of processors, controllers, etc., may be used as substitute for the display processor 127. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 may be communicatively coupled to the system memory 124 over a bus. In some examples, the processing unit 120 and the content encoder/decoder 122 may be communicatively coupled to the internal memory 121 over the bus or via a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, static random access memory (SRAM), dynamic random access memory (DRAM), erasable programmable ROM (EPROM), EEPROM, flash memory, a magnetic data media or an optical storage media, or any other type of memory. The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a CPU, a GPU, a GPGPU, or any other processing unit that may be configured to perform graphics processing. In some examples, the processing unit 120 may be integrated into a motherboard of the device 104. In further examples, the processing unit 120 may be present on a graphics card that is installed in a port of the motherboard of the device 104, or may be otherwise incorporated within a peripheral device configured to interoperate with the device 104. The processing unit 120 may include one or more processors, such as one or more microprocessors, GPUs, ASICs, FPGAs, arithmetic logic units (ALUs), DSPs, discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, and/or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include a device split-compute orchestrator 198 configured to obtain an executable for an application including a first set of application functions associated with the UE and a second set of application functions associated with a computing device that is different from the UE; obtain an estimated quality of a link between the UE and the computing device; obtain, based on the estimated quality of the link, a split-compute configuration between the first set of application functions and the second set of application functions; and output an indication of the split-compute configuration. Although the following description may be focused on graphics processing, the concepts described herein may be applicable to other similar processing techniques, such as general purpose split-compute data processing.

A device, such as the device 104, may refer to any device, apparatus, or system configured to perform one or more techniques described herein. For example, a device may be a server, a base station, a user equipment, a client device, a station, an access point, a computer such as a personal computer, a desktop computer, a laptop computer, a tablet computer, a computer workstation, or a mainframe computer, an end product, an apparatus, a phone, a smart phone, a server, a video game platform or console, a handheld device such as a portable video game device or a personal digital assistant (PDA), a wearable computing device such as a smart watch, an augmented reality device, or a virtual reality device, a non-wearable device, a display or display device, a television, a television set-top box, an intermediate network device, a digital media player, a video streaming device, a content streaming device, an in-vehicle computer, any mobile device, any device configured to generate graphical content, or any device configured to perform one or more techniques described herein. Processes herein may be described as performed by a particular component (e.g., a GPU) but in other embodiments, may be performed using other components (e.g., a CPU) consistent with the disclosed embodiments.

GPUs can process multiple types of data or data packets in a GPU pipeline. For instance, in some aspects, a GPU can process two types of data or data packets, e.g., context register packets and draw call data. A context register packet can be a set of global state information, e.g., information regarding a global register, shading program, or constant data, which can regulate how a graphics context will be processed. For example, context register packets can include information regarding a color format. In some aspects of context register packets, there can be a bit or bits that indicate which workload belongs to a context register. Also, there can be multiple functions or programming running at the same time and/or in parallel. For example, functions or programming can describe a certain operation, e.g., the color mode or color format. Accordingly, a context register can define multiple states of a GPU.

Context states can be utilized to determine how an individual processing unit functions, e.g., a vertex fetcher (VFD), a vertex shader (VS), a shader processor, or a geometry processor, and/or in what mode the processing unit functions. In order to do so, GPUs can use context registers and programming data. In some aspects, a GPU can generate a workload, e.g., a vertex or pixel workload, in the pipeline based on the context register definition of a mode or state. Certain processing units, e.g., a VFD, can use these states to determine certain functions, e.g., how a vertex is assembled. As these modes or states can change, GPUs may need to change the corresponding context. Additionally, the workload that corresponds to the mode or state may follow the changing mode or state.

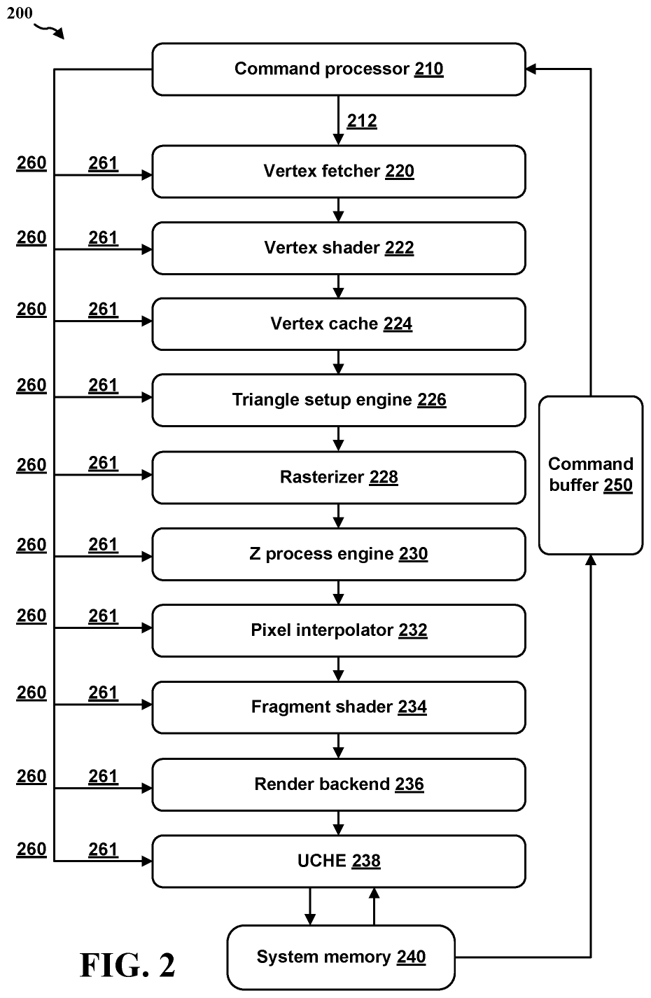

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, L2 cache (UCHE) 238, and system memory 240. Although FIG. 2 displays that GPU 200 includes processing units 220-238, GPU 200 can include a number of additional processing units. Additionally, processing units 220-238 are merely an example and any combination or order of processing units can be used by GPUs according to the present disclosure. GPU 200 also includes command buffer 250, context register packets 260, and context states 261.

As shown in FIG. 2, a GPU can utilize a CP, e.g., CP 210, or hardware accelerator to parse a command buffer into context register packets, e.g., context register packets 260, and/or draw call data packets, e.g., draw call packets 212. The CP 210 can then send the context register packets 260 or draw call packets 212 through separate paths to the processing units or blocks in the GPU. Further, the command buffer 250 can alternate different states of context registers and draw calls. For example, a command buffer can simultaneously store the following information: context register of context N, draw call(s) of context N, context register of context N+1, and draw call(s) of context N+1.

GPUs can render images in a variety of different ways. In some instances, GPUs can render an image using direct rendering and/or tiled rendering. In tiled rendering GPUs, an image can be divided or separated into different sections or tiles. After the division of the image, each section or tile can be rendered separately. Tiled rendering GPUs can divide computer graphics images into a grid format, such that each portion of the grid, i.e., a tile, is separately rendered. In some aspects of tiled rendering, during a binning pass, an image can be divided into different bins or tiles. In some aspects, during the binning pass, a visibility stream can be constructed where visible primitives or draw calls can be identified. A rendering pass may be performed after the binning pass. In contrast to tiled rendering, direct rendering does not divide the frame into smaller bins or tiles. Rather, in direct rendering, the entire frame is rendered at a single time (i.e., without a binning pass). Additionally, some types of GPUs can allow for both tiled rendering and direct rendering (e.g., flex rendering).

In some aspects, GPUs can apply the drawing or rendering process to different bins or tiles. For instance, a GPU can render to one bin, and perform all the draws for the primitives or pixels in the bin. During the process of rendering to a bin, the render targets can be located in GPU internal memory (GMEM). In some instances, after rendering to one bin, the content of the render targets can be moved to a system memory and the GMEM can be freed for rendering the next bin. Additionally, a GPU can render to another bin, and perform the draws for the primitives or pixels in that bin. Therefore, in some aspects, there might be a small number of bins, e.g., four bins, that cover all of the draws in one surface. Further, GPUs can cycle through all of the draws in one bin, but perform the draws for the draw calls that are visible, i.e., draw calls that include visible geometry. In some aspects, a visibility stream can be generated, e.g., in a binning pass, to determine the visibility information of each primitive in an image or scene. For instance, this visibility stream can identify whether a certain primitive is visible or not. In some aspects, this information can be used to remove primitives that are not visible so that the non-visible primitives are not rendered, e.g., in the rendering pass. Also, at least some of the primitives that are identified as visible can be rendered in the rendering pass.

In some aspects of tiled rendering, there can be multiple processing phases or passes. For instance, the rendering can be performed in two passes, e.g., a binning, a visibility or bin-visibility pass and a rendering or bin-rendering pass. During a visibility pass, a GPU can input a rendering workload, record the positions of the primitives or triangles, and then determine which primitives or triangles fall into which bin or area. In some aspects of a visibility pass, GPUs can also identify or mark the visibility of each primitive or triangle in a visibility stream. During a rendering pass, a GPU can input the visibility stream and process one bin or area at a time. In some aspects, the visibility stream can be analyzed to determine which primitives, or vertices of primitives, are visible or not visible. As such, the primitives, or vertices of primitives, that are visible may be processed. By doing so, GPUs can reduce the unnecessary workload of processing or rendering primitives or triangles that are not visible.

In some aspects, during a visibility pass, certain types of primitive geometry, e.g., position-only geometry, may be processed. Additionally, depending on the position or location of the primitives or triangles, the primitives may be sorted into different bins or areas. In some instances, sorting primitives or triangles into different bins may be performed by determining visibility information for these primitives or triangles. For example, GPUs may determine or write visibility information of each primitive in each bin or area, e.g., in a system memory. This visibility information can be used to determine or generate a visibility stream. In a rendering pass, the primitives in each bin can be rendered separately. In these instances, the visibility stream can be fetched from memory and used to remove primitives which are not visible for that bin.

Some aspects of GPUs or GPU architectures can provide a number of different options for rendering, e.g., software rendering and hardware rendering. In software rendering, a driver or CPU can replicate an entire frame geometry by processing each view one time. Additionally, some different states may be changed depending on the view. As such, in software rendering, the software can replicate the entire workload by changing some states that may be utilized to render for each viewpoint in an image. In certain aspects, as GPUs may be submitting the same workload multiple times for each viewpoint in an image, there may be an increased amount of overhead. In hardware rendering, the hardware or GPU may be responsible for replicating or processing the geometry for each viewpoint in an image. Accordingly, the hardware can manage the replication or processing of the primitives or triangles for each viewpoint in an image.

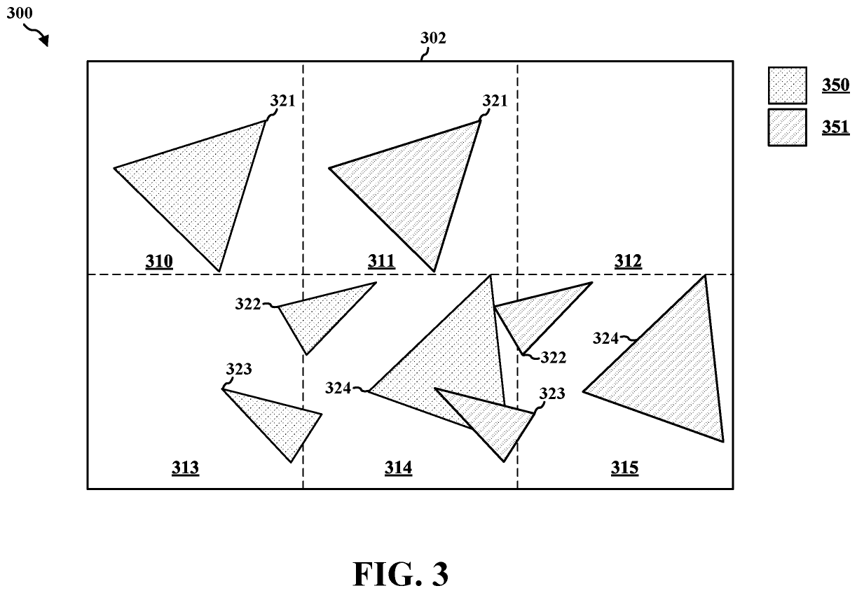

FIG. 3 illustrates image or surface 300, including multiple primitives divided into multiple bins in accordance with one or more techniques of this disclosure. As shown in FIG. 3, image or surface 300 includes area 302, which includes primitives 321, 322, 323, and 324. The primitives 321, 322, 323, and 324 are divided or placed into different bins, e.g., bins 310, 311, 312, 313, 314, and 315. FIG. 3 illustrates an example of tiled rendering using multiple viewpoints for the primitives 321-324. For instance, primitives 321-324 are in first viewpoint 350 and second viewpoint 351. As such, the GPU processing or rendering the image or surface 300 including area 302 can utilize multiple viewpoints or multi-view rendering.

As indicated herein, GPUs or graphics processors can use a tiled rendering architecture to reduce power consumption or save memory bandwidth. As further stated above, this rendering method can divide the scene into multiple bins, as well as include a visibility pass that identifies the triangles that are visible in each bin. Thus, in tiled rendering, a full screen can be divided into multiple bins or tiles. The scene can then be rendered multiple times, e.g., one or more times for each bin.

In aspects of graphics rendering, some graphics applications may render to a single target, i.e., a render target, one or more times. For instance, in graphics rendering, a frame buffer on a system memory may be updated multiple times. The frame buffer can be a portion of memory or random access memory (RAM), e.g., containing a bitmap or storage, to help store display data for a GPU. The frame buffer can also be a memory buffer containing a complete frame of data. Additionally, the frame buffer can be a logic buffer. In some aspects, updating the frame buffer can be performed in bin or tile rendering, where, as discussed above, a surface is divided into multiple bins or tiles and then each bin or tile can be separately rendered. Further, in tiled rendering, the frame buffer can be partitioned into multiple bins or tiles.

As indicated herein, in some aspects, such as in bin or tiled rendering architecture, frame buffers can have data stored or written to them repeatedly, e.g., when rendering from different types of memory. This can be referred to as resolving and unresolving the frame buffer or system memory. For example, when storing or writing to one frame buffer and then switching to another frame buffer, the data or information on the frame buffer can be resolved from the GMEM at the GPU to the system memory, i.e., memory in the double data rate (DDR) RAM or dynamic RAM (DRAM).

In some aspects, the system memory can also be system-on-chip (SoC) memory or another chip-based memory to store data or information, e.g., on a device or smart phone. The system memory can also be physical data storage that is shared by the CPU and/or the GPU. In some aspects, the system memory can be a DRAM chip, e.g., on a device or smart phone. Accordingly, SoC memory can be a chip-based manner in which to store data.

In some aspects, the GMEM can be on-chip memory at the GPU, which can be implemented by static RAM (SRAM). Additionally, GMEM can be stored on a device, e.g., a smart phone. As indicated herein, data or information can be transferred between the system memory or DRAM and the GMEM, e.g., at a device. In some aspects, the system memory or DRAM can be at the CPU or GPU. Additionally, data can be stored at the DDR or DRAM. In some aspects, such as in bin or tiled rendering, a small portion of the memory can be stored at the GPU, e.g., at the GMEM. In some instances, storing data at the GMEM may utilize a larger processing workload and/or consume more power compared to storing data at the frame buffer or system memory.

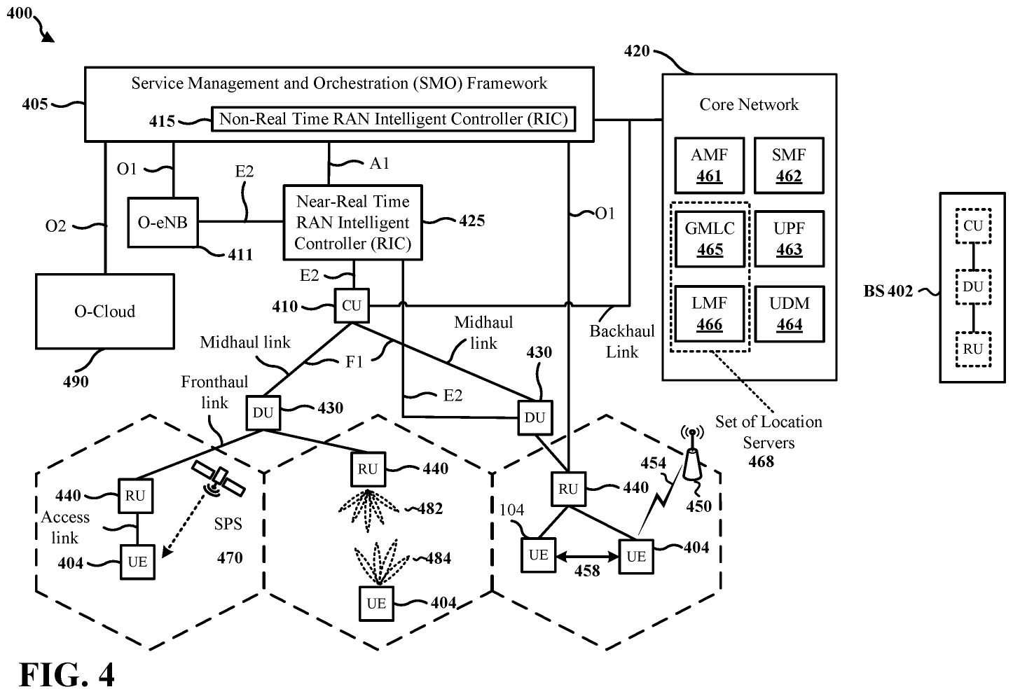

FIG. 4 is a diagram 400 illustrating an example of a wireless communications system and an access network. The illustrated wireless communications system includes a disaggregated base station architecture. The disaggregated base station architecture may include one or more CUs 410 that can communicate directly with a core network 420 via a backhaul link, or indirectly with the core network 420 through one or more disaggregated base station units (such as a Near-Real Time (Near-RT) RAN Intelligent Controller (RIC) 425 via an E2 link, or a Non-Real Time (Non-RT) RIC 415 associated with a Service Management and Orchestration (SMO) Framework 405, or both). A CU 410 may communicate with one or more DUs 430 via respective midhaul links, such as an F1 interface. The DUs 430 may communicate with one or more RUs 440 via respective fronthaul links. The RUs 440 may communicate with respective UEs 404 via one or more radio frequency (RF) access links. In some implementations, the UE 404 may be simultaneously served by multiple RUs 440.

Each of the units, i.e., the CUs 410, the DUs 430, the RUs 440, as well as the Near-RT RICs 425, the Non-RT RICs 415, and the SMO Framework 405, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 410 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., Central Unit-User Plane (CU-UP)), control plane functionality (i.e., Central Unit-Control Plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as an E1 interface when implemented in an O-RAN configuration. The CU 410 can be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 6GPP. In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 404. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a vRAN architecture.

The SMO Framework 405 may be configured to support RAN deployment and provisioning of non-virtualized and virtualized network elements. For non-virtualized network elements, the SMO Framework 405 may be configured to support the deployment of dedicated physical resources for RAN coverage specifications that may be managed via an operations and maintenance interface (such as an O1 interface). For virtualized network elements, the SMO Framework 405 may be configured to interact with a cloud computing platform (such as an open cloud (O-Cloud) 490) to perform network element life cycle management (such as to instantiate virtualized network elements) via a cloud computing platform interface (such as an O2 interface). Such virtualized network elements can include, but are not limited to, CUs 410, DUs 430, RUs 440 and Near-RT RICs 425. In some implementations, the SMO Framework 405 can communicate with a hardware aspect of a 4G RAN, such as an open eNB (O-eNB) 411, via an O1 interface. Additionally, in some implementations, the SMO Framework 405 can communicate directly with one or more RUs 440 via an O1 interface. The SMO Framework 405 also may include a Non-RT RIC 415 configured to support functionality of the SMO Framework 405.

The Non-RT RIC 415 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 425. The Non-RT RIC 415 may be coupled to or communicate with (such as via an A1 interface) the Near-RT RIC 425. The Near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the Near-RT RIC 425.

In some implementations, to generate AI/ML models to be deployed in the Near-RT RIC 425, the Non-RT RIC 415 may receive parameters or external enrichment information from external servers. Such information may be utilized by the Near-RT RIC 425 and may be received at the SMO Framework 405 or the Non-RT RIC 415 from non-network data sources or from network functions. In some examples, the Non-RT RIC 415 or the Near-RT RIC 425 may be configured to tune RAN behavior or performance. For example, the Non-RT RIC 415 may monitor long-term trends and patterns for performance and employ AI/ML models to perform corrective actions through the SMO Framework 405 (such as reconfiguration via 01) or via creation of RAN management policies (such as A1 policies).

At least one of the CU 410, the DU 430, and the RU 440 may be referred to as a base station 402. Accordingly, a base station 402 may include one or more of the CU 410, the DU 430, and the RU 440 (each component indicated with dotted lines to signify that each component may or may not be included in the base station 402). The base station 402 provides an access point to the core network 420 for a UE 404. The base stations 402 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 440 and the UEs 404 may include uplink (UL) (also referred to as reverse link) transmissions from a UE 404 to an RU 440 and/or downlink (DL) (also referred to as forward link) transmissions from an RU 440 to a UE 404. The communication links may use multiple-input and multiple-output (MIMO) antenna technology, including spatial multiplexing, beamforming, and/or transmit diversity. The communication links may be through one or more carriers. The base stations 402/UEs 404 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 404 may communicate with each other using device-to-device (D2D) communication link 458. The D2D communication link 458 may use the DL/UL wireless wide area network (WWAN) spectrum. The D2D communication link 458 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi™ based on the Institute of Electrical and Electronics Engineers (IEEE) 802.11 standard, LTE, or NR.

The wireless communications system may further include a Wi-Fi AP 450 in communication with UEs 404 (also referred to as Wi-Fi stations (STAs)) via communication link 454, e.g., in a 5 GHz unlicensed frequency spectrum or the like. When communicating in an unlicensed frequency spectrum, the UEs 404/AP 450 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a sub-6 GHz band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 402 and the UE 404 may each include a plurality of antennas, such as antenna elements, antenna panels, and/or antenna arrays to facilitate beamforming. The base station 402 may transmit a beamformed signal 482 to the UE 404 in one or more transmit directions. The UE 404 may receive the beamformed signal from the base station 402 in one or more receive directions. The UE 404 may also transmit a beamformed signal 484 to the base station 402 in one or more transmit directions. The base station 402 may receive the beamformed signal from the UE 404 in one or more receive directions. The base station 402/UE 404 may perform beam training to determine the best receive and transmit directions for each of the base station 402/UE 404. The transmit and receive directions for the base station 402 may or may not be the same. The transmit and receive directions for the UE 404 may or may not be the same.

The base station 402 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 402 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 420 may include an Access and Mobility Management Function (AMF) 461, a Session Management Function (SMF) 462, a User Plane Function (UPF) 463, a Unified Data Management (UDM) 464, one or more location servers 468, and other functional entities. The AMF 461 is the control node that processes the signaling between the UEs 404 and the core network 420. The AMF 461 supports registration management, connection management, mobility management, and other functions. The SMF 462 supports session management and other functions. The UPF 463 supports packet routing, packet forwarding, and other functions. The UDM 464 supports the generation of authentication and key agreement (AKA) credentials, user identification handling, access authorization, and subscription management. The one or more location servers 468 are illustrated as including a Gateway Mobile Location Center (GMLC) 465 and a Location Management Function (LMF) 466. However, generally, the one or more location servers 468 may include one or more location/positioning servers, which may include one or more of the GMLC 465, the LMF 466, a position determination entity (PDE), a serving mobile location center (SMLC), a mobile positioning center (MPC), or the like. The GMLC 465 and the LMF 466 support UE location services. The GMLC 465 provides an interface for clients/applications (e.g., emergency services) for accessing UE positioning information. The LMF 466 receives measurements and assistance information from the NG-RAN and the UE 404 via the AMF 461 to compute the position of the UE 404. The NG-RAN may utilize one or more positioning methods in order to determine the position of the UE 404. Positioning the UE 404 may involve signal measurements, a position estimate, and an optional velocity computation based on the measurements. The signal measurements may be made by the UE 404 and/or the base station 402 serving the UE 404. The signals measured may be based on one or more of a satellite positioning system (SPS) 470 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 404 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 404 may be referred to as IoT devices (e.g., parking meter, gas pump, toaster, vehicles, heart monitor, etc.). The UE 404 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

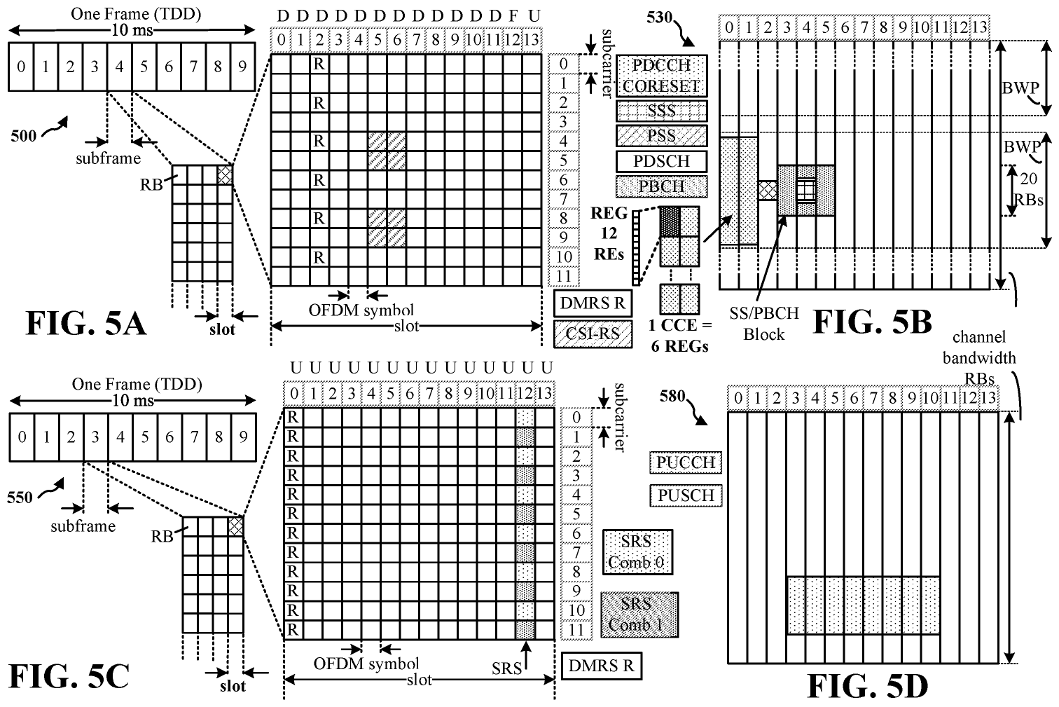

FIG. 5A is a diagram 500 illustrating an example of a first subframe within a 5G NR frame structure. FIG. 5B is a diagram 530 illustrating an example of DL channels within a 5G NR subframe. FIG. 5C is a diagram 550 illustrating an example of a second subframe within a 5G NR frame structure. FIG. 5D is a diagram 580 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 5A, 5C, the 5G NR frame structure is assumed to be TDD, with subframe 4 being configured with slot format 58 (with mostly DL), where D is DL, U is UL, and F is flexible for use between DL/UL, and subframe 6 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 5A-5D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 46 slots, respectively, per subframe. For extended CP, the numerology 2 allows for 4 slots per subframe. Accordingly, for normal CP and numerology p, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 5A-5D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 5B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 5A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 5B illustrates an example of various DL channels within a subframe of a frame. The physical downlink control channel (PDCCH) carries DCI within one or more control channel elements (CCEs) (e.g., 1, 2, 4, 8, or 46 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 404 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 5C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 5D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

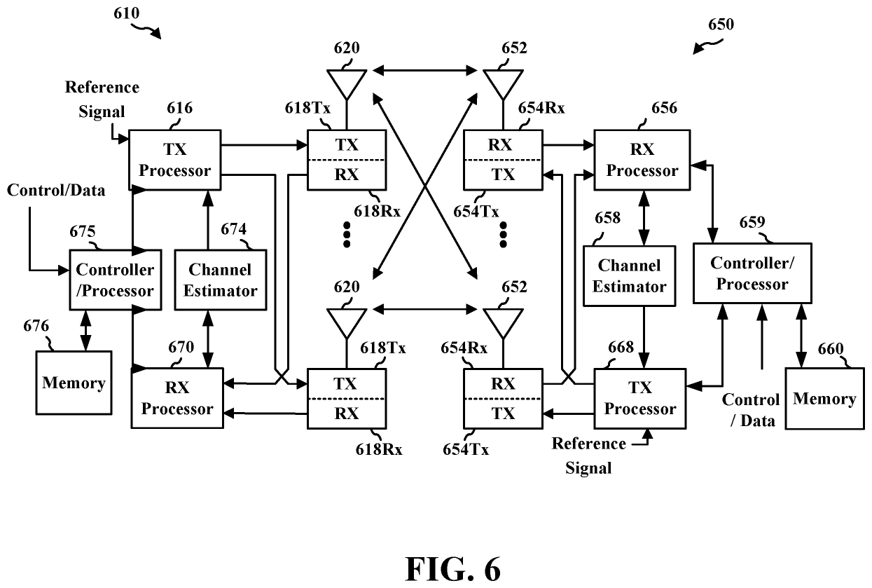

FIG. 6 is a block diagram of a base station 610 in communication with a UE 650 in an access network. In the DL, Internet protocol (IP) packets may be provided to a controller/processor 675. The controller/processor 675 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 675 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 616 and the receive (RX) processor 670 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 616 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream may then be provided to a different antenna 620 via a separate transmitter 618Tx. Each transmitter 618Tx may modulate a radio frequency (RF) carrier with a respective spatial stream for transmission.

At the UE 650, each receiver 654Rx receives a signal through its respective antenna 652. Each receiver 654Rx recovers information modulated onto an RF carrier and provides the information to the receive (RX) processor 656. The TX processor 668 and the RX processor 656 implement layer 1 functionality associated with various signal processing functions. The RX processor 656 may perform spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 610. These soft decisions may be based on channel estimates computed by the channel estimator 658. The soft decisions are then decoded and deinterleaved to recover the data and control signals that were originally transmitted by the base station 610 on the physical channel. The data and control signals are then provided to the controller/processor 659, which implements layer 3 and layer 2 functionality.

The controller/processor 659 can be associated with a memory 660 that stores program codes and data. The memory 660 may be referred to as a computer-readable medium. In the UL, the controller/processor 659 provides demultiplexing between transport and logical channels, packet reassembly, deciphering, header decompression, and control signal processing to recover IP packets. The controller/processor 659 is also responsible for error detection using an ACK and/or NACK protocol to support HARQ operations.

Similar to the functionality described in connection with the DL transmission by the base station 610, the controller/processor 659 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 658 from a reference signal or feedback transmitted by the base station 610 may be used by the TX processor 668 to select the appropriate coding and modulation schemes, and to facilitate spatial processing. The spatial streams generated by the TX processor 668 may be provided to different antenna 652 via separate transmitters 654Tx. Each transmitter 654Tx may modulate an RF carrier with a respective spatial stream for transmission.

The UL transmission is processed at the base station 610 in a manner similar to that described in connection with the receiver function at the UE 650. Each receiver 618Rx receives a signal through its respective antenna 620. Each receiver 618Rx recovers information modulated onto an RF carrier and provides the information to a RX processor 670.

The controller/processor 675 can be associated with a memory 676 that stores program codes and data. The memory 676 may be referred to as a computer-readable medium. In the UL, the controller/processor 675 provides demultiplexing between transport and logical channels, packet reassembly, deciphering, header decompression, control signal processing to recover IP packets. The controller/processor 675 is also responsible for error detection using an ACK and/or NACK protocol to support HARQ operations.

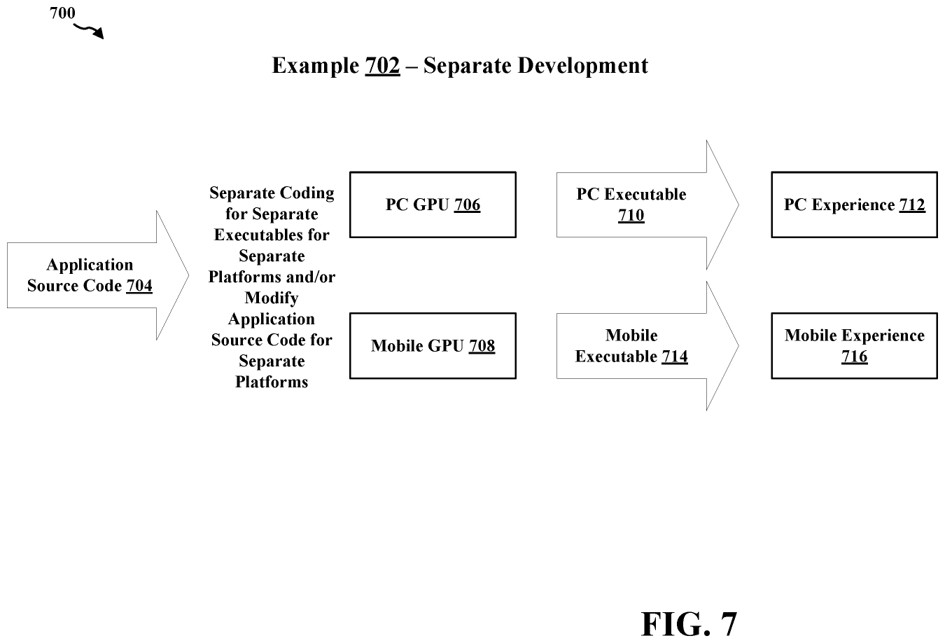

FIG. 7 is a diagram 700 illustrating development processes for a personal computer (PC) executable and a mobile executable for an application in accordance with one or more techniques of this disclosure. Mobile devices (e.g., mobile phones) may have less capabilities and computing power compared to PCs. For example, a mobile device (e.g., a phone) may include a first type of a graphics processor and a PC (e.g., a desktop computer) may include a second type of graphics processor, where performance attribute(s) of the second type of graphics processor are greater than performance attribute(s) of the first type of graphics processor. For instance, the second type of graphics processor may have a higher clock rate and/or a greater amount of memory in comparison to the first type of graphics processor. As a result, an experience of the application of the mobile device may be relatively limited compared to an experience of the application on the PC. For instance, when executed on the mobile device, the application may have lower frame rates, lower resolution, etc. in comparison to when the application is executed on the PC. A frame rate may refer to a number of frames per second that are rendered on a computing device. Lower frame results may result in a lower quality user experience as the user may see artifacts in displayed frames. A resolution may refer to a number of pixels displayed to a user. Example resolutions may include 720p, 1080p (HD), 4K, and 8K. Higher resolutions may provide for a better user experience but may also utilize a higher bandwidth.

An application developer may develop two versions of an application (e.g., a game) to run on the mobile device and the PC, respectively. In some situations, an application developer may have insufficient resources to code and support two versions of the application and hence the application developer may choose to support one version of the application instead of two versions of the application. In other situations, the application developer may code and support two versions of the application (e.g., a first version of the application to run on the PC (i.e., on a PC GPU) and a second version of the application to run on the mobile device (i.e., on a mobile device GPU)); however, coding and supporting two versions of the application may utilize a relatively large amount of computing resources and/or developer time in comparison to coding and supporting a single version of the application.

The diagram 700 depicts an example 702 of development processes for PC and mobile. An application developer may develop application source code 704 for an application. The application source code 704 may be configured for a PC GPU 706 or a mobile GPU 708. In an example, the application source code 704 may be configured for the PC GPU 706 and the application developer may modify (i.e., recode) the application source code 704 such that the application source code 704 may be configured for the mobile GPU 708. For instance, the application developer may recode the application source code 704 to function on the mobile GPU 708 with less rendering capability. When the application source code 704 is configured for the PC GPU 706, the application source code 704 may be compiled into a PC executable 710. When the PC executable 710 is executed by a PC, a PC experience 712 for the application may be provided to a user. When the application source code 704 is configured for the mobile GPU, the application source code 704 may be compiled into a mobile executable 714. When the mobile executable 714 is executed by a mobile device, a mobile experience 716 for the application may be provided to the user. In an example, the PC experience 712 may include higher frame rates, higher resolutions, and/or more features in comparison to the mobile experience 716.

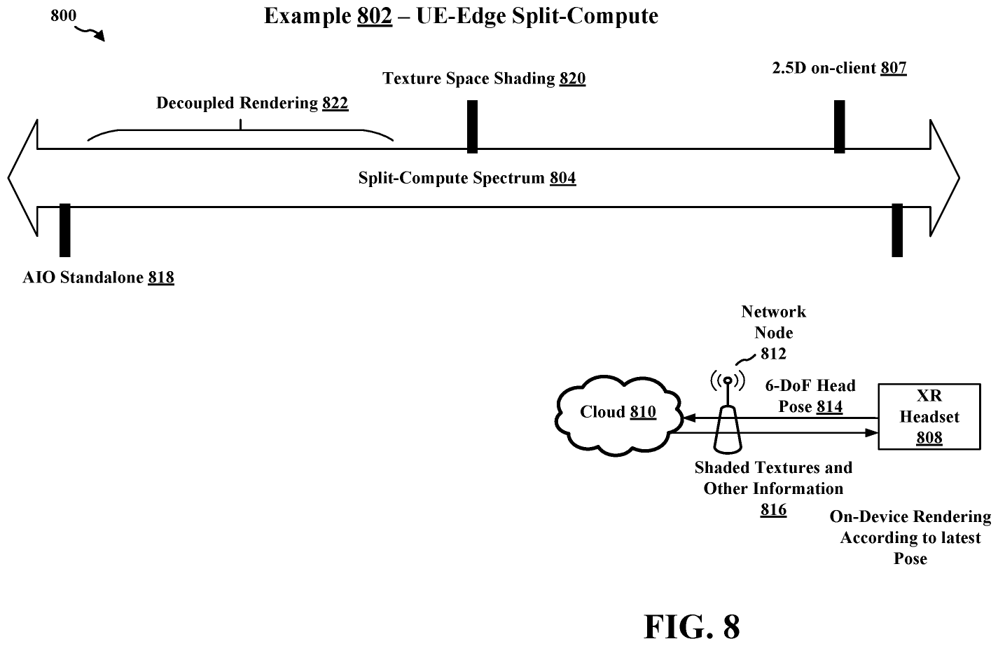

FIG. 8 is a diagram 800 illustrating an example 802 of a UE-Edge split-compute spectrum in accordance with one or more techniques of this disclosure. Split-compute may refer to a paradigm that enables an application executing on a mobile device (e.g., a UE) to provide the same (or similar experience) to a user as when the application executes on a PC while conserving power consumption of the mobile device via data and/or communications exchanged between the mobile device and an edge (which may also be referred to as a node, a compute node, a server, the cloud, etc.) over link(s). The link(s) may include a wireless local area network (WLAN) link and/or a radio access network (RAN) link such as a 5G NR link.

Split-compute may be associated with a split-compute spectrum 804. One end of the split-compute spectrum 804 may be fully remote 806 (i.e., ultra-thin client). For example, an XR headset 808 may be a wearable device with a relatively low capacity battery. The XR headset 808 may execute a thin client for an application. When executing the thin client, the XR headset 808 may transmit 6-degrees of freedom (DoF) head pose information 814 to the cloud 810 via a network node 812 (e.g., a 5G NR network node). A majority of rendering for the application may be performed in the cloud 810 (e.g., on server(s), on the edge, on compute nodes, etc.). The cloud 810 may transmit shaded textures and other information 816 to the XR headset 808 via the network node 812. Stated differently, the cloud 810 may transmit pre-rendered content (or nearly pre-rendered content) to the XR headset 808. The XR headset 808 may perform minor processing (e.g., late stage reprojection) on the pre-rendered content and display the processed content to the user. Thus, a user may be able to have a high-end experience associated with a high-end processor on a device with a relatively low-end processor while saving power. However, the aforementioned high-end experience may depend on a quality of a link (e.g., a WLAN link, a 5G NR link etc.) between the XR headset 808 and the cloud 810. If a link is not reliable, dropouts and other interruptions may occur when the application executes. Fully remote 806 may be associated with a relatively high amount of computation on the edge, a relatively low amount of computation on a device, a relatively high amount of bandwidth being utilized, and a relatively low amount of device battery power being consumed.

The split-compute spectrum 804 may include 2.5D on-client 807. In 2.5D on-client, a client may perform additional work to re-project 2D video based on a current pose of the user/viewer.

Another end of the split-compute spectrum 804 may be all-in-one (AIO) standalone 818. In AIO standalone 818, an application executes entirely (or nearly entirely) on a device without assistance from the edge. AIO standalone 818 may be associated with a relatively low amount of computation on the edge (e.g., none), a relatively high amount of computation on the device, a relatively low amount of bandwidth being utilized (e.g., none), and a relatively high amount of device battery power being consumed.

Texture space shading 820 (which may also be referred to as vector streaming) may lie between AIO standalone 818 and fully remote 806 on the split-compute spectrum 804. In texture space shading 820, the edge may send assets (e.g., textures) to a device such that the device is able to perform some rendering without assistance of the edge if a link between the device and the edge is interrupted.

Decoupled rendering 822 (which may also be referred to as split-compute offload) may also lie between AIO standalone 818 and fully remote 806 on the split-compute spectrum 804. In decoupled rendering 822, an amount of computation performed on the device and an amount of computation performed on the edge may be continually adjusted based on various factors, such as a quality of link(s) between the device and the edge. In an example, the quality of the link(s) may include an amount of available bandwidth of the link(s), a latency of the link(s), and/or an error rate for transmissions sent across the link(s).

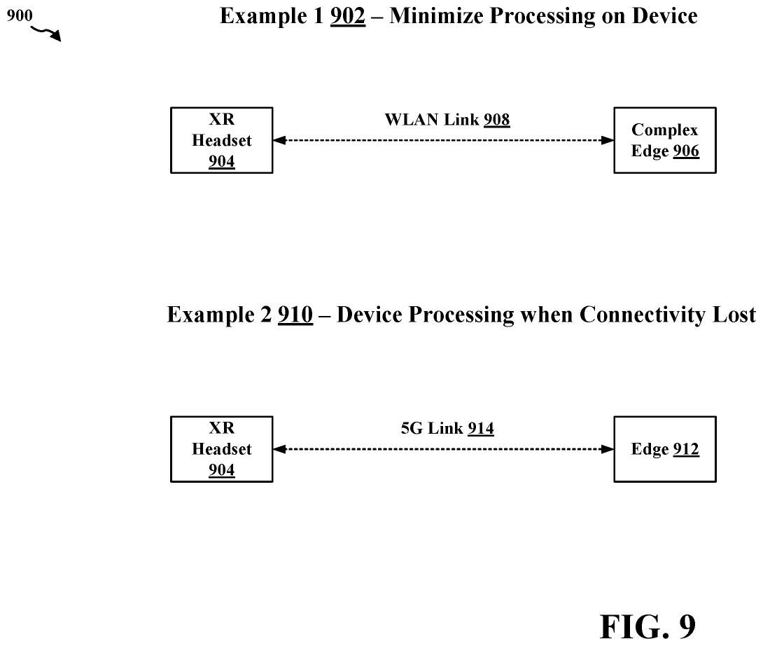

FIG. 9 is a diagram 900 illustrating examples of split-compute strategies in accordance with one or more techniques of this disclosure. In a first example 902, an XR headset 904 (or another device) and a complex edge 906 (e.g., a server, a node, a compute node, the cloud, etc.) may be utilized in a split-compute configuration. The XR headset 904 and the complex edge 906 may communicate over a WLAN link 908. In the first example 902, processing is minimized on the XR headset 904 and processing is maximized on the complex edge 906. However, as processing is maximized on the complex edge, if a quality of the WLAN link 908 degrades, user experience on the XR headset 904 may be affected.

In a second example 910, the XR headset 904 (or another device) and an edge 912 (e.g., a server, a node, a compute node, the cloud, etc.) may be utilized in a split-compute configuration. The XR headset 904 and the edge 912 may communicate over a 5G link 914 (i.e., a 5G NR link). In the second example 910, processing may be performed on the XR headset 904 if a quality of the 5G link 914 degrades (e.g., if the 5G link 914 is reduced or lost).

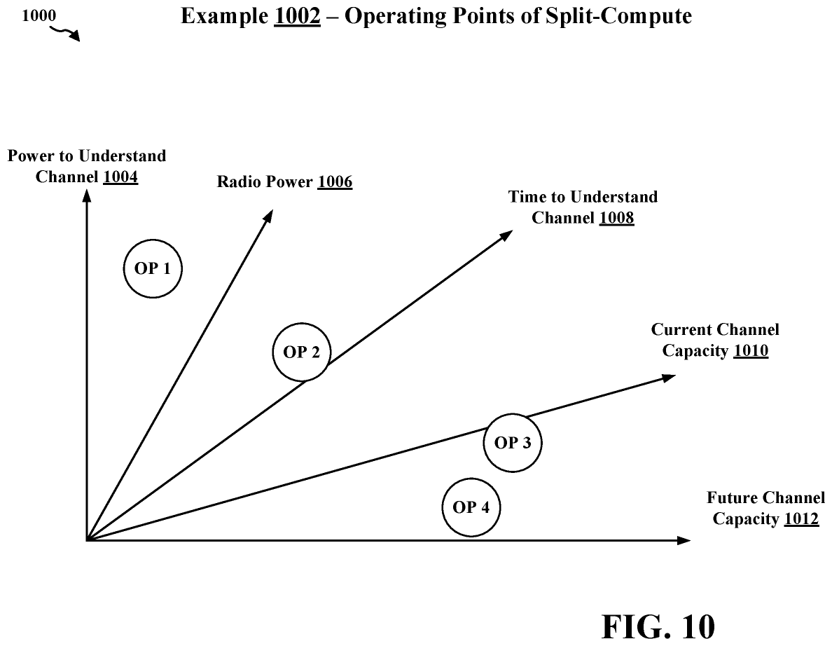

FIG. 10 is a diagram 1000 illustrating an example 1002 of operating points of split-compute in accordance with one or more techniques of this disclosure. Various factors such as an amount of device power to understand a channel 1004, an amount of radio power 1006 used by the device, an amount of time to understand a channel 1008 (in order for the channel to be predicted), a current channel capacity 1010, and/or future channel capacity 1012 may be associated with selecting a split-compute configuration. For instance, a split-compute load distribution may adapt continuously and/or between one or more operating points (OPs) associated with the aforementioned factors.

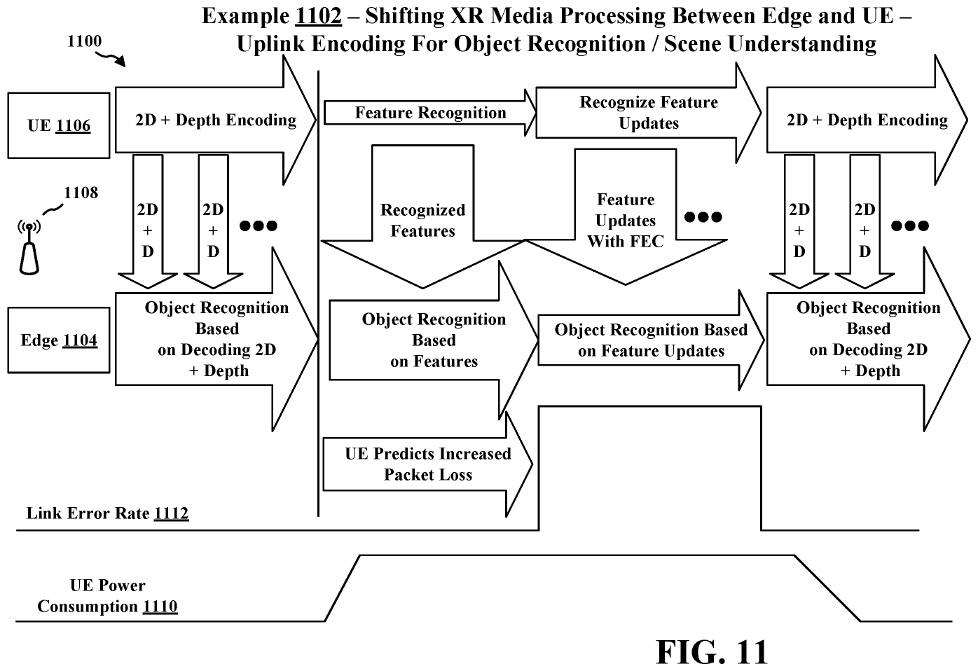

FIG. 11 is a diagram 1100 illustrating an example 1102 of shifting extended reality (XR) media processing between an edge 1104 and a UE 1106 in accordance with one or more techniques of this disclosure. The example 1102 pertains to uplink encoding for object recognition and scene understanding. In an example, the UE 1106 may be an XR headset and the edge 1104 may be a server, a node, a compute node, the cloud, etc. The example 1102 may be associated with a split-compute configuration.

The UE 1106 may determine an encoding for two-dimensional and depth information (2D+Depth encoding) associated with an application executed by the UE 1106. The UE 1106 may transmit the 2D+Depth encoding to the edge 1104 via a network node 1108 (e.g., a base station). The edge may perform object recognition based on decoding the 2D+Depth encoding.

The UE 1106 may predict an increased packet loss in the future based on measurements of the communications link and/or from environmental sensors. To prepare for the upcoming increased packet rate, the UE 1106 may perform feature recognition based on data generated by the application and start sending this information to the edge 1104 while the communications link is still good (low error rate). When the communication link starts to experience higher packet loss, the UE 1106 may transmit the recognized features to the edge 1104 via the network node 1108 by using error protection codes. Performing feature recognition to enable the UE 1106 to send more compressed information during the period of increased packet loss may be associated with an increase in UE power consumption 1110. The edge 1104 may perform object recognition based on the recognized features.

Subsequently, the packet loss may occur, which may lead to an increase in a link error rate 1112 between the UE 1106 and the edge 1104. The UE 1106 may recognize a feature update based on data generated by the application. The UE 1106 may transmit a feature update with a forward error correction (FEC) code to the edge 1104 via the network node 1108. The edge 1104 may perform object recognition based on the feature update updates with the FEC code.

Subsequently, the packet loss may end, which may lead to a decrease in the link error rate 1112 and a reduction in the UE power consumption 1110. The UE 1106 may determine additional 2D+Depth encoding associated with the application executed by the UE 1106. The UE 1106 may transmit the 2D+Depth encoding to the edge 1104 via a network node 1108 (e.g., a base station). The edge may perform object recognition based on decoding the 2D+Depth encoding.

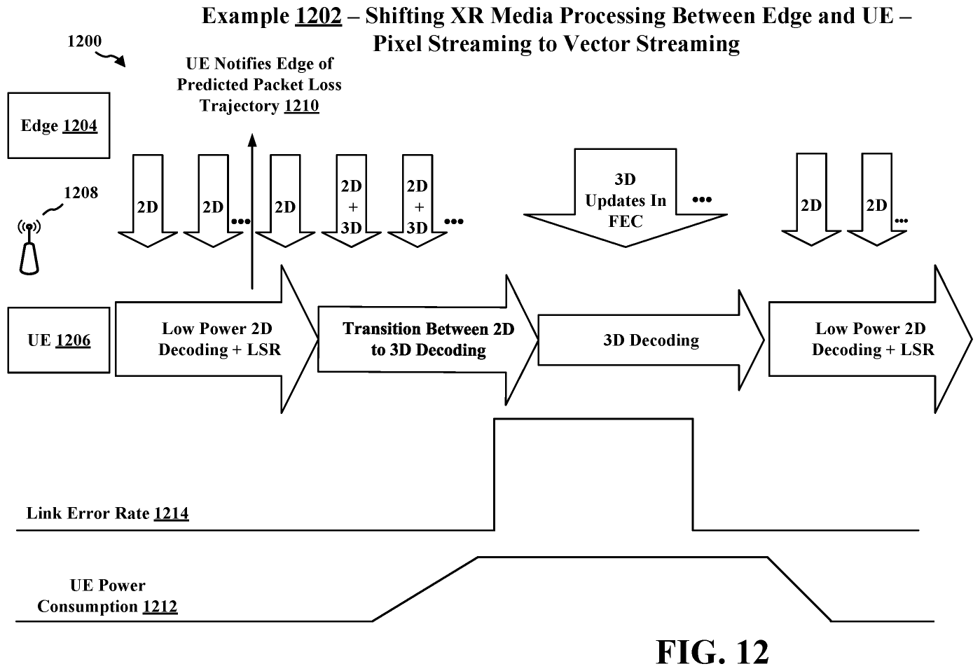

FIG. 12 is a diagram 1200 illustrating another example 1202 of XR media processing between an edge 1204 and a UE 1206 in accordance with one or more techniques of this disclosure. The example 1202 pertains to pixel streaming to vector streaming. In an example, the UE 1206 may be an XR headset and the edge 1204 may be a server, a node, a compute node, the cloud, etc. The example 1202 may be associated with a split-compute configuration.

The edge 1204 may generate a 2D encoding and transmit the 2D encoding to the UE 1206 via a network node 1208 (e.g., a base station). The UE 1206 may perform low power 2D decoding on the 2D encoding along with late stage reprojection (LSR). LSR may refer to a UE adjusting a 2D video frame from an edge to match changes in a view/pose of a user that have occurred after the edge rendered a video frame. At 1210, the UE 1206 may notify the edge 1204 of a predicted packet loss trajectory. The edge 1204 may transmit a 2D encoding and a 3D encoding to the UE 1206 via the network node 1208. The UE may transition from 2D decoding to 3D decoding. Transitioning from 2D decoding to 3D decoding may cause an increase in UE power consumption 1212.

Subsequently, the predicted packet loss may occur, which may lead to an increase in a link error rate 1214 between the edge 1204 and the UE 1206. The edge 1204 may transmit 3D updates that specify less bandwidth with a FEC code to the UE 1206 via the network node 1208. The UE may perform 3D decoding based on the 3D updates with the FEC code.

Subsequently, the packet loss may end, which may lead to a reduction in the link error rate 1214. The edge 1204 may generate an additional 2D encoding and transmit the additional 2D encoding to the UE 1206 via a network node 1208. The UE 1206 may perform low power 2D decoding on the 2D encoding along with LSR. Performing the low power 2D decoding may reduce the UE power consumption 1212.

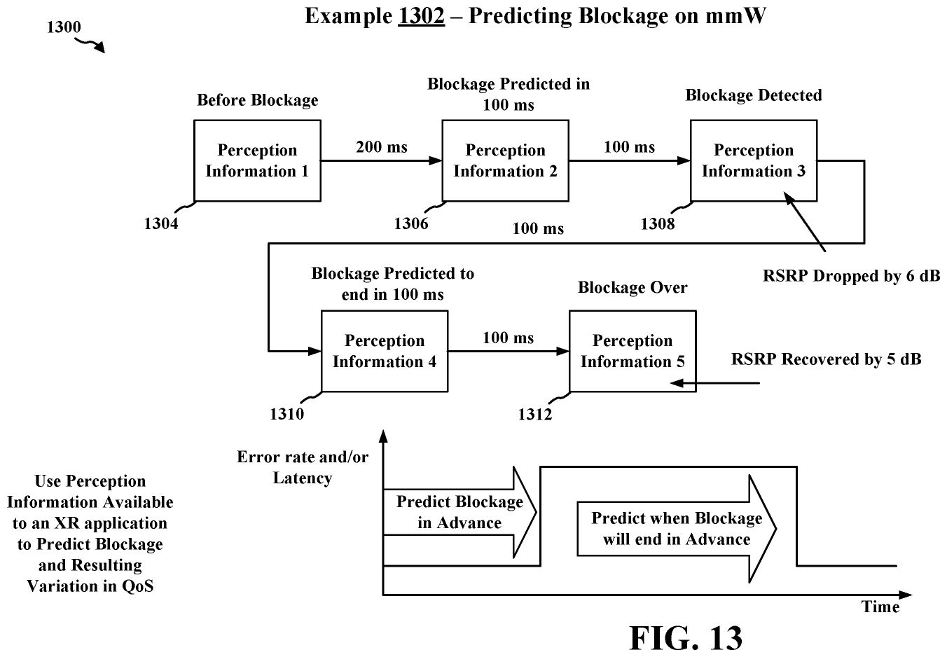

FIG. 13 is a diagram 1300 illustrating an example 1302 of predicting a millimeter wave (mmW) blockage while an XR application is executing in accordance with one or more techniques of this disclosure. An XR headset may generate perception information as the XR headset executes an XR application. The perception information may be based upon sensor data generated by sensors of the XR headset. The XR headset may utilize the perception information available to the XR application to predict a (future) blockage and a resulting variation in a quality of service (QoS). For instance, the blockage may affect a quality of a link between the XR headset and an edge (e.g., a server, a node, a compute node, the cloud, etc.). In an example, the XR headset may adjust a split-compute configuration based on predicting the blockage.

In an example, at 1304, an XR headset may generate first perception information. At 1306, 200 ms after generating the first perception information, the XR headset may generate second perception information. The XR headset may predict that a blockage is to occur in 100 ms based on the second perception information. At 1308, 100 ms after generating the second perception information, the XR headset may generate third perception information. The XR headset may detect that the blockage has occurred based on the third perception information. For instance, the XR headset may detect the blockage based on a reference signal received power (RSRP) measurement. For instance, the XR headset may determine that an RSRP measurement at 1308 has dropped by 6 dB relative to 1306. The blockage may be associated with an increased error rate and/or latency of transmissions sent to/from the XR headset. At 1310, 100 ms after generating the third perception information, the XR headset may generate fourth perception information. The XR headset may predict that the blockage will end in 100 ms based on the fourth perception information. At 1312, 100 ms after generating the fourth perception information, the XR headset may generate fifth perception information. The XR headset may detect that the blockage has ended based on the fifth perception information. For instance, the XR headset may determine that an RSRP measurement at 1312 has increased by 5 dB relative to 1310.

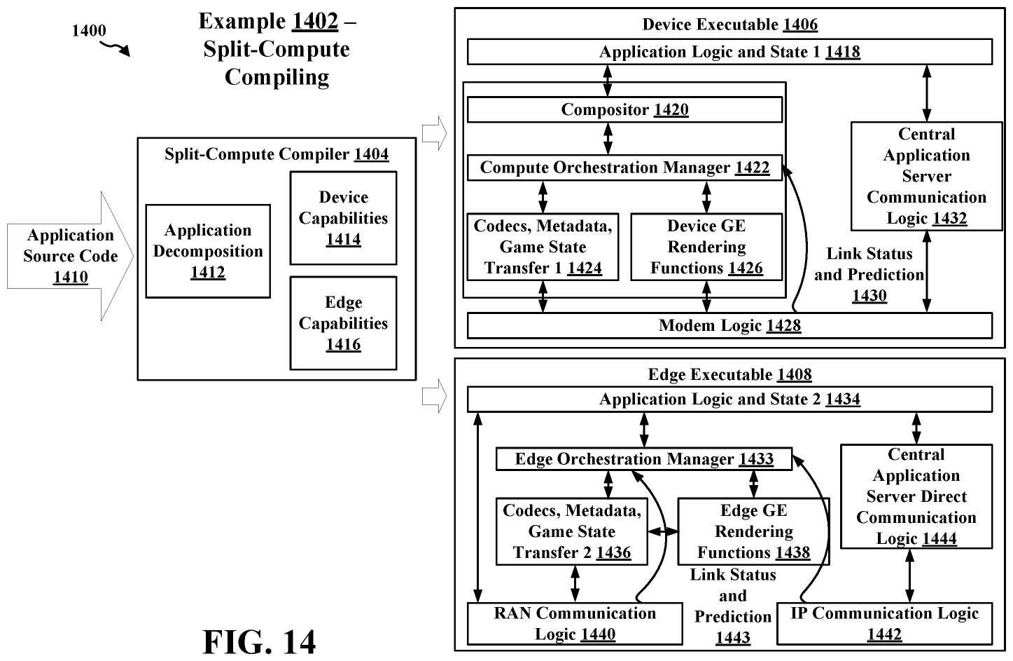

FIG. 14 is a diagram 1400 illustrating an example 1402 of a split-compute compiler 1404 that generates a device executable 1406 and an edge executable 1408 in accordance with one or more techniques of this disclosure. The example 1402 may pertain to decomposing an application and game engine (GE) across a radio link. The example 1402 may pertain to enabling the application and the GE to be logically decomposed into split processing components across separate compute nodes of varying complexity. The example 1402 may enable an application to be written once for a variety of platforms (e.g., on mobile graphics processors and discrete graphics processors). As such, the example 1402 may enable a developer to avoid developing different versions of the same application for the variety of platforms. Furthermore, the example 1402 may provide a consistent application experience (e.g., consistent performance) over both mobile and PC-based platforms. Additionally, the example 1402 may provide for flexible and dynamic adjustments of split-compute configurations.

The split-compute compiler 1404 may obtain application source code 1410 (i.e., source code for an application). The split-compute compiler 1404 may perform an application decomposition 1412 based on the application source code 1410, where the application decomposition 1412 produces (or generates or identifies) device capabilities 1414 for a device (e.g., a UE, an XR headset, a mobile phone, etc.) and edge capabilities 1416 for an edge (e.g., a server, a node, a compute node, etc.). The device capabilities 1414 and the edge capabilities 1416 may be based on computing power and/or features of the device and the edge, respectively. The application decomposition 1412 may also produce/generate/identify a first set of application functions associated with the device (e.g., a UE) and a second set of application functions associated with the edge.

The split-compute compiler 1404 may generate (e.g., compile) the device executable 1406 for the device based on the application source code 1410 and the device capabilities 1414. The split-compute compiler 1404 may also generate (e.g., compile) the edge executable 1408 for the edge based on the application source code 1410 and the edge capabilities 1416. The device executable 1406 may include a first application logic and state 1418 for the application for the device, a compositor 1420, a compute orchestration manager 1422, first codecs, metadata, and game state transfer information 1424 for the application for the device, device GE rendering functions 1426, modem logic 1428, and central application server communication logic 1432 (i.e., logic for communication with a central application server). The edge executable 1408 may include an edge orchestration manager 1433, second application logic and state 1434, second codecs, metadata, and game state transfer information 1436 for the application for the edge, edge GE rendering functions 1438, RAN communication logic 1440 (i.e., logic for communication with the device via a RAN, such as a 5G NR RAN), IP communication logic 1442 (i.e., logic for communication with the device via IP), and central application server direct communication logic 1444 (i.e., logic for direct communication with a central application server).

In some aspects, the compute orchestration manager 1422 may determine which tasks are to be performed by the device and which tasks are to be performed by the edge. The compute orchestration manager 1422 may send tasks for rendering to the device GE rendering functions 1426. The compute orchestration manager 1422 may receive rendered results (e.g., device-rendered media) from the device GE rendering functions 1426. The compute orchestration manager 1422 may also access the first codecs, metadata, and game state transfer information 1424 for the application for the device in order to facilitate functionality performed by the application for the device. The first codecs, metadata, and game state transfer information 1424 and the device GE rendering functions 1426 may be collectively referred to as “UE application functions,” “device application functions,” or “a first set of application functions associated with the UE.” The compute orchestration manager 1422 may be or include the device split-compute orchestrator 198.

In some aspects, the edge orchestration manager 1433 may determine which tasks are to be performed by the device and which tasks are to be performed by the edge. The edge orchestration manager 1433 may send tasks for rendering to the edge GE rendering functions 1438. The edge orchestration manager 1433 may receive rendered results from the edge GE rendering functions 1438. The edge GE rendering functions 1438 may be configured to handle higher complexity rendering compared to the device GE rendering functions 1426. The edge orchestration manager 1433 may also access the second codecs, metadata, and game state transfer information 1436 for the application for the edge in order to facilitate functionality performed by the application for the device. The second codecs, metadata, and game state transfer information 1436 and the edge GE rendering functions 1438 may be collectively referred to as “edge application functions,” “server application functions,” or “a second set of application functions associated with a server.”

The modem logic 1428 may include logic for transmitting/receiving data to/from the edge. In an example, the modem logic 1428 may include first logic for communicating via a RAN (e.g., a 5G NR RAN) and second logic for communicating via IP (e.g., via a WLAN). The modem logic 1428 may include logic for determining quality of link(s) between the device and the edge and for predicting future quality of the link(s) between the device and the edge. The quality of the link(s) may include a bandwidth associated with the link(s), a latency associated with the link(s), and/or an error rate associated with the link(s). The modem logic 1428 may provide a link status and a prediction 1430 to the compute orchestration manager 1422. The compute orchestration manager 1422 may determine which tasks are to be performed by the device and which tasks are to be performed by the edge based on the link status and prediction 1430. Stated differently, the compute orchestration manager 1422 may select a split-compute configuration between the device and the edge based on the link status and prediction 1430. The compute orchestration manager 1422 may request that the edge perform certain tasks based on the selected split-compute configuration. For instance, the compute orchestration manager may request (e.g., via the modem logic 1428) that the edge render certain assets (e.g., graphical objects) associated with the application.

The RAN communication logic 1440 may include logic for transmitting/receiving data to/from the device via a RAN. The IP communication logic 1442 may include logic for transmitting/receiving data to/from the device via IP. The RAN communication logic 1440 and/or the IP communication logic 1442 may include logic for determining quality of link(s) between the device and the edge and for predicting future quality of the link(s) between the device and the edge. The quality of the link(s) may include a bandwidth associated with the link(s), a latency associated with the link(s), and/or an error rate associated with the link(s). The RAN communication logic 1440 and/or the IP communication logic 1442 may provide a link status and a prediction 1443 to the edge orchestration manager 1433. The edge orchestration manager 1433 may determine which tasks are to be performed by the device and which tasks are to be performed by the edge based on the link status and prediction 1443. Stated differently, the edge orchestration manager 1433 may select a split-compute configuration between the device and the edge based on the link status and prediction 1443. The edge orchestration manager 1433 may request that the device perform certain tasks based on the selected split-compute configuration. For instance, the edge orchestration manager 1433 may request (e.g., via the RAN communication logic 1440 and/or the IP communication logic 1442) that the UE render certain assets (e.g., graphical objects) associated with the application.

The device executable 1406 may also include a compositor 1420 that may communicate with the first application logic and state 1418 and the compute orchestration manager 1422. The compositor 1420 may determine an ordering of different objects that are rendered. For instance, the compositor 1420 may determine which objects are to be located in front of other objects. The compositor 1420 may create a final image based on different layers associated with an image, where the different layers may be associated with different transparencies, depth orders, etc. In an example, the compute orchestration manager 1422 (or the edge orchestration manager 1433) may select a split-compute configuration that indicates that first assets are to be rendered on the device and second assets are to be rendered on the edge. The compute orchestration manager 1422 may obtain the first assets (e.g., a first object to be displayed, a first layer to be displayed, etc.) from the device GE rendering functions 1426 and the compute orchestration manager 1422 may obtain the second assets (e.g., a second object to be displayed, a second layer to be displayed, etc.) from the edge. The compute orchestration manager 1422 may provide the first assets and the second assets to the compositor 1420, where the compositor 1420 may determine the ordering of the first assets and the second assets. The compositor 1420 may provide an indication of the ordering of the first assets and the second assets to the first application logic and state 1418, where the first application logic and state 1418 may cause the first assets and the second assets to be displayed based on the indication of the ordering.

In some aspects, the first application logic and state 1418 may be identical to the second application logic and state 1434 such that the device and the edge each run separate instances of the application. In other aspects, the second application logic and state 1434 may be a subset of the first application logic and state 1418. In an example, the first application logic and state 1418 may include information that enables the device to run the application with or without assistance from the edge and the second application logic and state 1434 may include information that enables the edge to perform functionality (e.g., rendering) in a split-compute configuration without the edge being able to fully run a separate instance of the application.

As noted above, the device executable 1406 may include central application server communication logic 1432. For instance, the application may be a multiplayer game played on different devices by different players and the central application server communication logic 1432 may enable the device to communicate with the central application server. In an example, the device may establish a session with the central application server using the central application server communication logic 1432. The device may obtain state information and/or media information from the central application server via the central application server communication logic 1432. The device may synchronize with the edge based on the state information and/or the media information. In another example, the edge may establish a session with the central application server using the central application server direct communication logic 1444. The edge may obtain state information and/or media information from the central application server via the central application server direct communication logic 1444. The edge may synchronize with the device based on the state information and/or the media information.

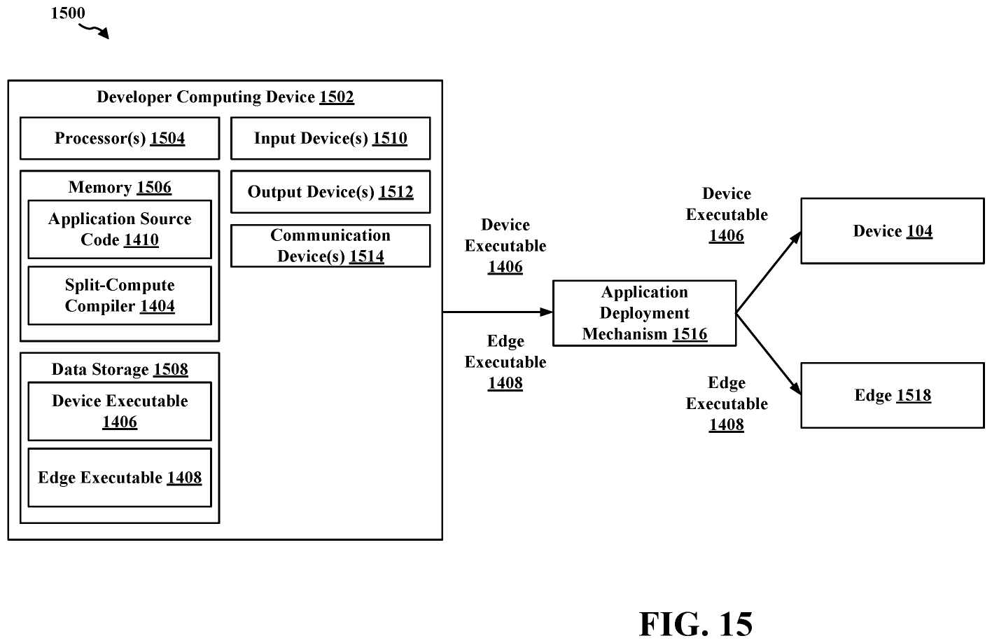

FIG. 15 is a diagram 1500 illustrating an example of a developer computing device 1502 that includes a split-compute compiler in accordance with one or more techniques of this disclosure. As will be discussed below, the developer computing device 1502 may be utilized by a developer to develop an application. The developer computing device 1502 may include processor(s) 1504. The processor(s) 1504 may include CPUs and/or GPUs. The developer computing device 1502 may include memory 1506, where the memory 1506 may store the application source code 1410 and the split-compute compiler 1404 described above. The developer computing device 1502 may include data storage 1508, where the data storage 1508 may include the device executable 1406 and the edge executable 1408 described above. For instance, the processor(s) 1504 of the developer computing device 1502 may execute the split-compute compiler 1404 on the application source code 1410 in order to generate the device executable 1406 and the edge executable 1408. The application source code 1410 and/or the split-compute compiler 1404 may also be stored in the memory 1506.

The developer computing device 1502 may include input device(s) 1510 that enable the developer computing device 1502 to receive input from a user (e.g., a developer). In an example, the input may be associated with developing the application source code 1410. The input device(s) 1510 may include a mouse, a keyboard, a touchscreen, a scroll wheel, a microphone, etc. The developer computing device 1502 may include output device(s) 1512 that enable the developer computing device 1502 to output information to a user (e.g., a developer). The output device(s) 1512 may include a display (e.g., a touchscreen display), a speaker, a printer, etc. The developer computing device 1502 may include communication device(s) 1514 that enable the developer computing device 1502 to communicate with other computing devices. In an example, the communication device(s) 1514 may include a modem.

The developer computing device 1502 may execute the split-compute compiler 1404 and generate the device executable 1406 and the edge executable 1408 as described above. The developer computing device 1502 may provide the device executable 1406 and the edge executable 1408 to an application deployment mechanism 1516 (e.g., an online application store). For example, the developer computing device 1502 may upload the device executable 1406 and the edge executable 1408 to the application deployment mechanism 1516 via the communication device(s) 1514. The application deployment mechanism 1516 may transmit the device executable 1406 to the device 104 and the edge executable 1408 to an edge 1518. As noted above, the edge 1518 may be or include a server, a compute node, a node, the cloud, etc.

In certain aspects, the split-compute compiler 1404 and/or the developer computing device 1502 may be configured to obtain source code for an application; decompose the source code into a first set of application functions associated with a user equipment (UE) and a second set of application functions associated with at least one server, where at least one of the first set of application functions or the second set of application functions are associated with a quality of a link between the UE and the at least one server; generate a first executable for the UE based on the first set of application functions and a second executable for the at least one server based on the second set of application functions; and provide the first executable for the UE and the second executable for the at least one server.

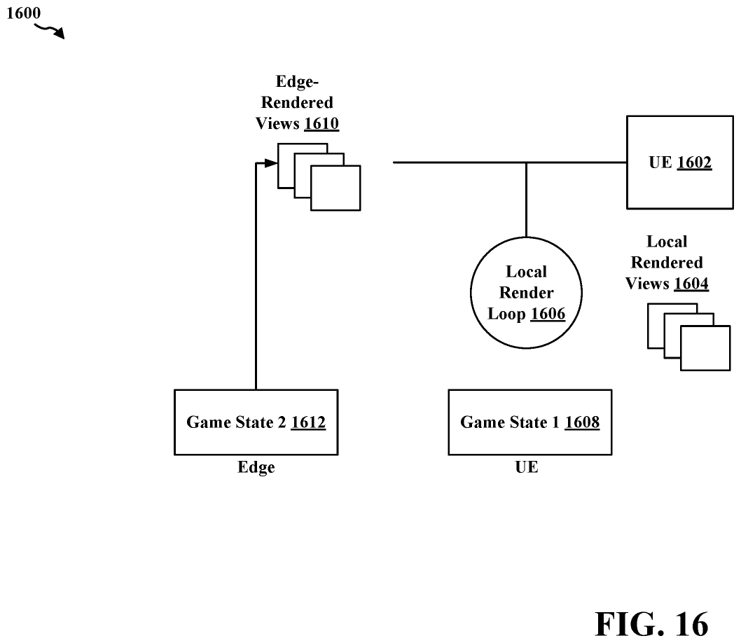

FIG. 16 is a diagram 1600 illustrating an example of a shared game state between an edge and a UE (i.e., a device) in accordance with one or more techniques of this disclosure. A UE 1602 may generate local rendered views 1604 (e.g., UE-rendered media) via a local render loop 1606 while executing the device executable 1406 for the application. The UE 1602 may maintain a first game state 1608 while executing the device executable 1406. For instance, the first game state 1608 may include first details pertaining to graphical objects of the application. Similarly, an edge may generate edge-rendered views 1610 while executing the edge executable 1408. The edge may maintain a second game state 1612 while executing the edge executable 1408. For instance, the second game state 1612 may include second details pertaining to the graphical objects of the application. The UE 1602 and the edge may synchronize the first game state 1608 and the second game state 1612. The UE 1602 may include logic to switch between local rendering (e.g., the local rendered views 1604) and displaying remote rendered views (e.g., the edge-rendered views) based on a quality of a link between the UE 1602 and the edge. Stated differently, the UE 1602 may include a render pipeline for applications (e.g., mobile applications) with support for split rendering.

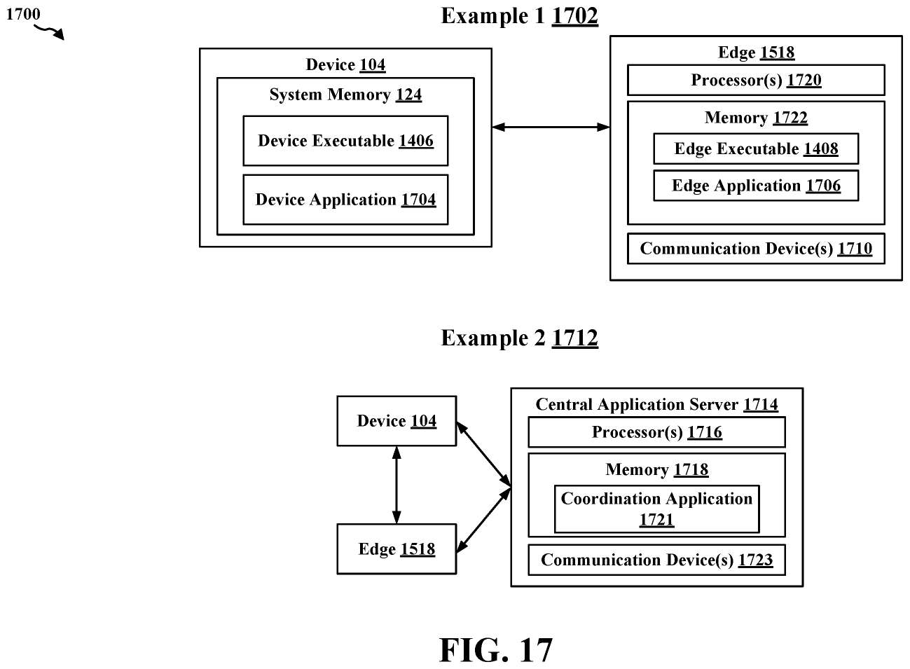

FIG. 17 is a diagram 1700 illustrating examples of a device, a server, and a central application server in accordance with one or more techniques of this disclosure. In a first example 1702, the device 104 may execute the device executable 1406 which causes a device application 1704 to be run on the device 104. The edge 1518 may include processor(s) 1720. The processor(s) 1720 may be or include graphics processor(s) (e.g., GPUs) and/or CPUs). The edge 1518 may include memory 1722 that stores the edge executable 1408. The edge 1518 may execute the edge executable 1408 which causes an edge application 1706 to be run on the edge 1518. The edge 1518 may also include communication device(s) 1710 (e.g., a modem or IP router interface) that enable the edge 1518 to communicate with the device 104 (as well as other devices).

In a second example 1712, the device 104 and the edge 1518 may communicate with a central application server 1714. The central application server 1714 may include processor(s) 1716 (e.g., graphics processors, CPUs, etc.). The central application server 1714 may include memory 1718 storing a coordination application 1721 that coordinates transfer of information between the device 104, the edge 1518, and other devices (not illustrated in FIG. 17). In an example, the device application 1704 and the edge application 1706 may be associated with a multiplayer game or multi-user virtual environment such as the metaverse, and the coordination application 1721 may communicate state information and media information to the device 104, the edge 1518, and the other devices (not illustrated in FIG. 17). The central application server 1714 may also include communication device(s) 1723 (e.g., a modem or IP router interface) that enable the central application server 1714 to communicate with the device 104, the edge 1518, and the other devices (not illustrated in FIG. 17).

In certain aspects, the edge 1518 may be configured to obtain an executable for an application including a first set of application functions associated with a UE and a second set of application functions associated with the server; obtain an estimated quality of a link between the UE and the server; obtain, based on the estimated quality of the link, a split-compute configuration between the first set of application functions and the second set of application functions; and output an indication of the split-compute configuration.

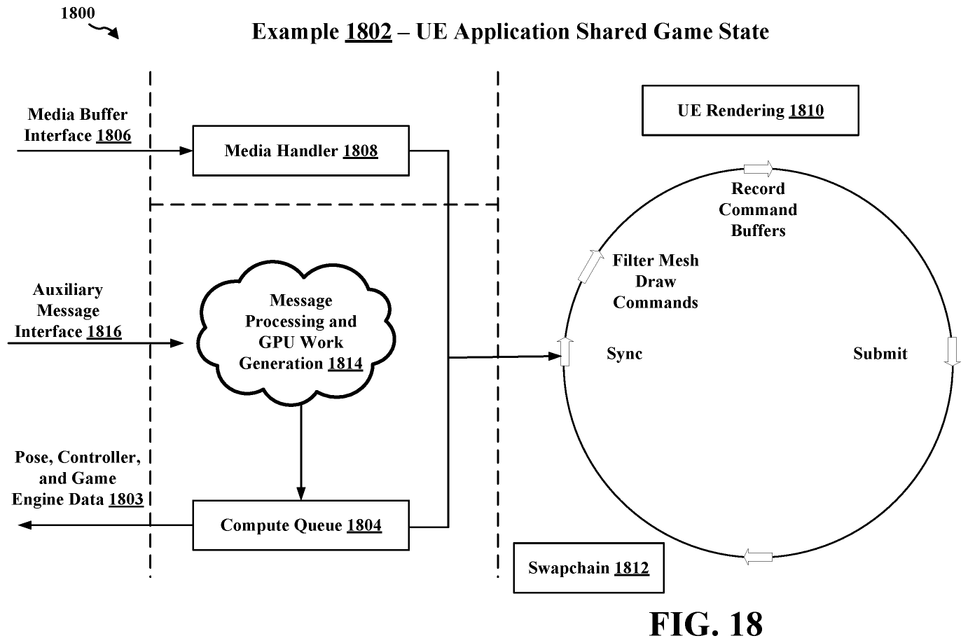

FIG. 18 is a diagram 1800 illustrating an example 1802 of a UE application shared game state in accordance with one or more techniques of this disclosure. A UE may send pose, controller, and game engine data 1803 to an edge and the edge may render edge media information (“edge-rendered media”) based on the pose, controller, and game engine data 1803. In an example, the UE may send the pose, controller, and game engine data 1803 via a compute queue 1804 of the UE. A media buffer interface 1806 associated with the edge may provide the edge-rendered media to a media handler 1808 associated with a UE. The UE may also perform UE rendering 1810 to render UE media information (“UE-rendered media”). For instance, the UE may perform the UE rendering 1810 concurrently with receiving the edge-rendered media from the edge. The UE rendering 1810 may include filtering mesh draw commands, recording command buffers, submitting data for rendering, and syncing.

A swapchain 1812 of the UE may select the edge-rendered media (or a portion thereof) or the UE-rendered media (or a portion thereof) for final display on the UE based on various factors (e.g., a quality of a link between the UE and the edge). The swapchain 1812 may be a series of virtual framebuffers used by a graphics processor of the UE and/or a graphics application programming interface (API) of the UE for frame rate stabilization, stutter reduction, and other purposes. The UE may also include message processing/GPU work generation 1814 that may control the UE rendering 1810 based on various factors in order to reduce UE power consumption. For example, the message processing/GPU work generation 1814 may disable the UE rendering 1810 when a quality of a link between the UE and the edge meets a performance metric (e.g., when the link has a bandwidth that is able to accommodate a particular framerate, when the link has a latency that meets a target latency, when the link has an error rate that is lower than an error rate threshold, etc.). The message processing/GPU work generation 1814 may enable the UE rendering 1810 when the quality of the link between the UE and the edge does not meet the performance metric (e.g., when the link has a bandwidth that is unable to accommodate a particular framerate, when the link has a latency that does not meet a target latency, when the link has an error rate that is higher than an error rate threshold, etc.). The edge may also provide control information to the UE via an auxiliary message interface 1816. For instance, the edge may disable the UE rendering 1810 when a quality of a link between the UE and the edge meets a performance metric (e.g., when the link has a bandwidth that is able to accommodate a particular framerate, when the link has a latency that meets a target latency, when the link has an error rate that is lower than an error rate threshold, etc.). The edge may enable the UE rendering 1810 when a quality of a link between the UE and the edge does not meet a performance metric (e.g., when the link has a bandwidth that is unable to accommodate a particular framerate, when the link has a latency that does not meet a target latency, when the link has an error rate that is higher than an error rate threshold, etc.).

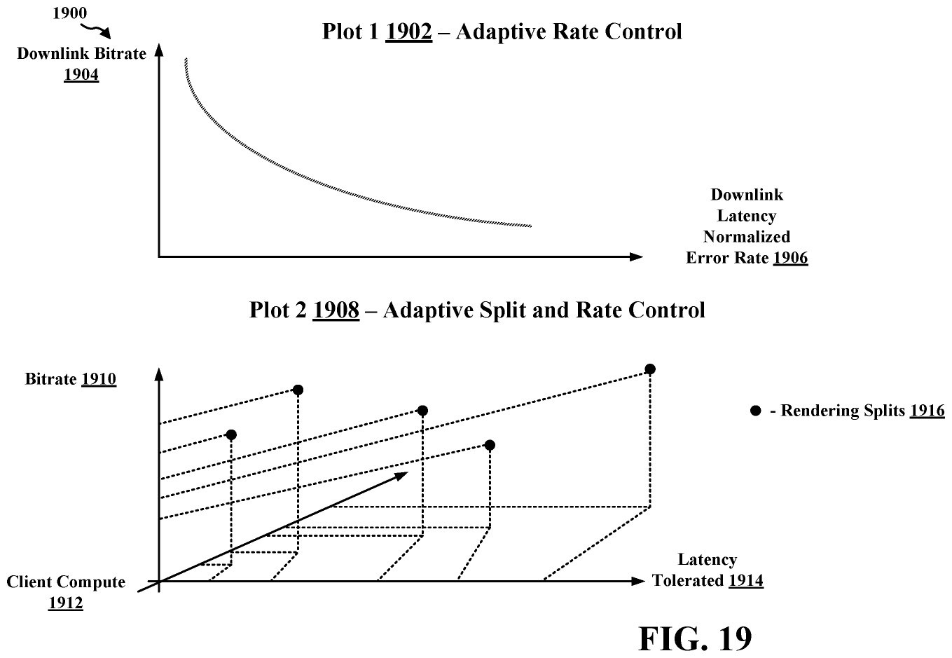

FIG. 19 is a diagram 1900 illustrating example aspects of adaptive rate control and adaptive split plus rate control in accordance with one or more techniques of this disclosure. A link (e.g., a WLAN link, a 5G NR link, etc.) may be used for state and media updates from a central application server in order to avoid latency, error, and data rate limitations associated with a central application server (e.g., the central application server 1714) to UE (e.g., the device 104) to edge (e.g., the edge 1518) path that may cross a wireless link twice. For instance, the link may enable an edge to be closely synchronized with a central application server. The link may also enable the edge to perform computations that the UE may utilize when the link quality meets a quality threshold. To accommodate the aforementioned synchronization and computation, a split session may be established with the central application server and both the UE and the edge. For instance, referring briefly to FIG. 17, a split session may be established with the central application server 1714 and the device 104 and the edge 1518. The central application server 1714 may distribute game/application state information and/or media and associated metadata to the device 104 and the edge 1518 in order to avoid “triangle-ing” the state information and/or the media information to the edge 1518. In an example involving an online multiplayer game, the edge 1518 may render assets (e.g., player characters) and the assets may be composited by the device 104 for display on the device 104.

Referring back to FIG. 19, the diagram 1900 includes a first plot 1902 of adaptive rate control (ARC). The first plot 1902 illustrates a downlink bitrate 1904 versus a downlink latency normalized error rate 1906. The first plot 1902 illustrates an expected ARC behavior within a fixed rendering split. The first plot 1902 may show that as congestion on a link increases, a rate (i.e., a video quality) may be decreased. Stated differently, as the downlink latency normalized error rate 1906 increases, the downlink bitrate 1904 may decrease. In an example, a UE and/or an edge may utilize aspects illustrated in the first plot 1902 to rate-adapt (i.e., change a bitrate of) media information in order to provide a gracefully-degraded user experience on the UE.

The diagram 1900 also includes a second plot 1908 of adaptive split and rate control. The second plot 1908 illustrates a bitrate 1910 versus client compute 1912 versus latency tolerated 1914. The second plot 1908 also illustrates (different) rendering splits 1916 (visually illustrated as darkened circles) with respect to the bitrate 1910, the client compute 1912, and the latency tolerated 1914. The rendering splits 1916 may also be referred to as split-compute configurations. A platform (i.e., a UE, an edge, a central application server, and/or a combination thereof) may support multiple rendering splits. When the (different) rendering splits 1916 are supported, an edge may dynamically determine a rendering split that is to be utilized based on post link sensing and/or client capabilities (i.e., UE capabilities). The second plot 1908 shows that increased split choices (i.e., increased split-compute configurations) may lead to a higher-dimensional approach for ARC and avoid gracefully degrading the user experience.

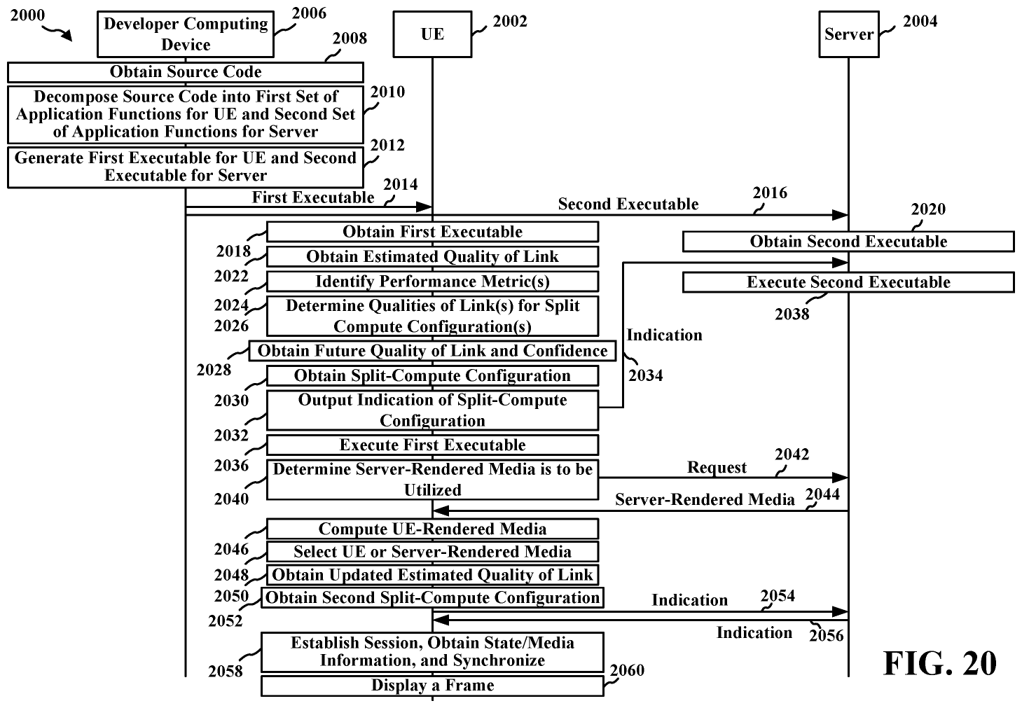

FIG. 20 is a call flow diagram 2000 illustrating example communications between a developer computing device 2006, a UE 2002, and a server 2004 in accordance with one or more techniques of this disclosure. At 2008, the developer computing device 2006 may obtain source code for an application. At 2010, the developer computing device 2006 may decompose the source code into a first set of application functions for the UE 2002 and a second set of application functions for the server 2004. In an example, decomposing the source code into the first set of application functions and the second set of application functions may be based on capabilities of the UE 2002 (e.g., a graphics processor of the UE 2002) and capabilities of the server 2004 (e.g., a graphics processor at the server 2004), respectively. At 2012, the developer computing device 2006 may generate a first executable for the UE 2002 based on the first set of application functions and a second executable for the server 2004 based on the second set of application functions. When executed by processor(s), the first executable and the second executable may cause a first instance of the application to run on the UE 2002 and a second instance of the application to run on the server 2004, respectively. At 2014, the developer computing device 2006 may cause the first executable to be deployed on the UE 2002 (e.g., via a content distribution mechanism). At 2016, the developer computing device 2006 may cause the second executable to be deployed on the server 2004 (e.g., via a content distribution mechanism).

At 2018, the UE 2002 may obtain the first executable. At 2020, the server 2004 may obtain the second executable. At 2022, the UE 2002 may obtain an estimated quality of a link (e.g., a WLAN link such as a Wi-Fi™, a RAN link such as a 5G NR link, etc.) between the UE 2002 and the server 2004. In one example, the UE 2002 may estimate the quality of the link via hardware and/or software of the UE 2002. In another example, the server 2004 may estimate the quality of the link via hardware and/or software of the server 2004 and the server 2004 may transmit an indication of the estimated quality of the link to the UE 2002. According to certain examples, the estimated quality of the link may be based on power consumed by the UE 2002, a set of power consumption characteristics of a transceiver and/or an antenna of the UE 2002, a current channel capacity of the link, and/or a future channel capacity of the link, as well as environmental sensor data such as a video image of the physical space that could affect the link quality.

At 2024, the UE 2002 may identify performance metric(s) associated with the application. The performance metric(s) may include a frame rate of the application on the UE 2002, a display resolution of the application on the UE 2002, and/or an operational state (e.g., whether the application is rendering to the user a high-motion fight scene or a slowly panned image of a scenic environment) of the application on the UE 2002. At 2026, the UE 2002 may determine corresponding qualities of link(s) for split-compute configuration(s).

At 2028, the UE 2002 may obtain a future quality of a link between the UE 2002 and the server 2004. In one example, at a first time instance, the UE 2002 may estimate the future quality of the link at a second time instance that occurs after the first time instance. In another example, at the first time instance, the server 2004 may estimate the future quality of the link at the second time instance that occurs after the first time instance and the server 2004 may transmit the indication of the future quality of the link to the UE 2002. Furthermore, at 2028, the UE 2002 may obtain a confidence level of the predicted future quality of the link. In one example, at the first time instance, the UE 2002 may estimate the confidence level. In another example, at the first time instance, the UE 2002 may receive an indication of the confidence level from the server 2004.

At 2030, the UE 2002 may obtain a split-compute configuration between the first set of application functions and the second set of application functions based on the estimated quality of the link. In one example, the UE 2002 may select the split-compute configuration (e.g., from amongst many different split-compute configurations) based on the estimated quality of the link. In another example, the server 2004 may select the split-compute configuration (e.g., from amongst many different split-compute configurations) based on the estimated quality of the link and the server 2004 may transmit an indication of the split-compute configuration to the UE 2002. In some aspects, the UE 2002 may obtain the split-compute configuration additionally based on the future quality of the link, the performance metric(s), and/or the corresponding qualities of link(s) for split-compute configuration(s).

At 2032, the UE 2002 may output an indication of the obtained split-compute configuration. For instance, at 2034, the UE 2002 may transmit an indication of the split-compute configuration to the server 2004. At 2036, the UE 2002 may execute the first executable based on the split-compute configuration obtained at 2030. Although the first executable is illustrated in the diagram as being executed after 2022, 2024, 2026, 2028, 2030, 2032, and 2034, the first executable may be executed concurrently with performance of 2022, 2024, 2026, 2028, 2030, 2032, and 2034. At 2038, the server 2004 may execute the second executable based on the split-compute configuration. Execution of the first executable and the second executable may cause graphical or 3D data (e.g., UE-rendered media and/or server-rendered media) to be displayed on a display of the UE 2002.

In one aspect, at 2040, the UE 2002 may determine that server-rendered media is to be utilized based on the split-compute configuration. At 2042, the UE 2002 may transmit a request for the server-rendered media to the server 2004. At 2044, the server 2004 may compute and transmit the server-rendered media to the UE 2002 based on receiving the request and the split-compute configuration. Alternatively, the server 2004 may transmit, based on the split-compute configuration, the server-rendered media to the UE 2002 without receiving a request from the UE 2002. In an example, the UE 2002 may present the server-rendered media on the display of the UE 2002.

In one aspect, at 2046, the UE 2002 may compute UE-rendered media based on the split-compute configuration. The UE 2002 may present the UE-rendered media on the display of the UE 2002. In an example, the UE 2002 may present the UE-rendered media concurrently with the server-rendered media. For instance, the server-rendered media may be media that is computationally intensive to render (e.g., ray-traced graphics) and the UE-rendered media may be media that is less computationally intensive to render compared to the server-rendered media. At 2048, the UE 2002 may select the UE-rendered media or the server-rendered media based on a swapchain. The UE 2002 may then present the selected media on the display.

At 2050, the UE 2002 may obtain an updated estimated quality of the link between the UE 2002 and the server 2004 at a time instance occurring after 2022. In one example, the UE 2002 may estimate the updated quality of the link. In another example, the server 2004 may estimate the updated quality of the link and the server 2004 may transmit an indication of the updated estimated quality of the link to the UE 2002.

At 2052, the UE 2002 may obtain a second split-compute configuration based on the updated estimated quality of the link. In one example, the UE 2002 may select the second split-compute configuration (e.g., from amongst many different split-compute configurations) based on the updated estimated quality of the link. In another example, the server 2004 may select the second split-compute configuration (e.g., from amongst many different split-compute configurations) based on the updated estimated quality of the link and the server 2004 may transmit an indication of the second split-compute configuration to the UE 2002. At 2054, the UE 2002 may transmit an indication of the second split-compute configuration to the server 2004. Alternatively, at 2054, the indication may indicate that the server 2004 is to select a second split-compute configuration or that the server 2004 is to rate-adapt information associated with the application.

In one aspect, at 2056, the UE 2002 may receive, from the server 2004, an indication that the UE 2002 is to select a second split-compute configuration or that the UE 2002 is to rate-adapt (e.g., change a bitrate of) information associated with the application. In one aspect, at 2058, the UE 2002 may establish a session with an application server for the application, obtain, from the application server and during the session, state information for the application and/or media information for the application, and synchronize with the server 2004 based on the state information and/or the media information. In one aspect, at 2060, the UE 2002 may display a frame generated based on the split-compute configuration.

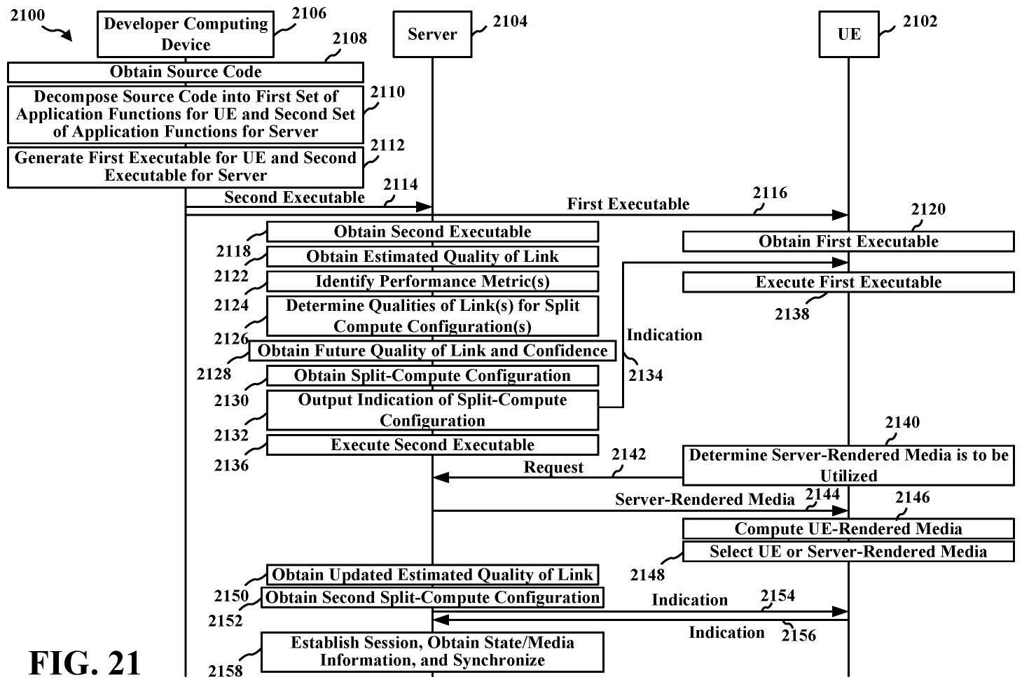

FIG. 21 is a call flow diagram 2100 illustrating example communications between a developer computing device 2106, a UE 2102, and a server 2104 in accordance with one or more techniques of this disclosure. At 2108, the developer computing device 2106 may obtain source code for an application. At 2110, the developer computing device 2106 may decompose the source code into a first set of application functions for the UE 2102 and a second set of application functions for the server 2104. In an example, decomposing the source code into the first set of application functions and the second set of application functions may be based on capabilities of the UE 2102 (e.g., a graphics processor of the UE 2102) and capabilities of the server 2104 (e.g., a graphics processor at the server 2104), respectively. At 2112, the developer computing device 2106 may generate a first executable for the UE 2102 based on the first set of application functions and a second executable for the server 2104 based on the second set of application functions. When executed by processor(s), the first executable and the second executable may cause a first instance of the application to run on the UE 2102 and a second instance of the application to run on the server 2104, respectively. At 2114, the developer computing device 2106 may cause the second executable to be deployed on the server 2104 (e.g., via a content distribution mechanism). At 2116, the developer computing device 2106 may cause the first executable to be deployed on the UE 2102 (e.g., via a content distribution mechanism).

At 2118, the server 2104 may obtain the second executable. At 2120, the UE 2102 may obtain the first executable. At 2122, the server 2104 may obtain an estimated quality of a link (e.g., a WLAN link, a RAN link such as a 5G NR link, etc.) between the UE 2102 and the server 2104. In one example, the server 2104 may estimate the quality of the link via hardware and/or software of the server 2104. In another example, the UE 2102 may estimate the quality of the link via hardware and/or software of the UE 2102 and the UE 2102 may transmit an indication of the estimated quality of the link to the server 2104. According to certain examples, the estimated quality of the link may be based on power consumed by the UE 2102, a set of power consumption characteristics of a transceiver and/or an antenna of the UE 2102, a current channel capacity of the link, and/or a future channel capacity of the link.

At 2124, the server 2104 may identify performance metric(s) associated with the application. The performance metric(s) may include a frame rate of the application on the UE 2102, a display resolution of the application on the UE 2102, and/or an operational state (e.g., an error rate) of the application on the UE 2102. At 2126, the server 2104 may determine corresponding qualities of link(s) for split-compute configuration(s).

At 2128, the server 2104 may obtain a future quality of a link between the UE 2102 and the server 2104. In one example, at a first time instance, the server 2104 may estimate the future quality of the link at a second time instance that occurs after the first time instance. In another example, at the first time instance, the UE 2102 may estimate the future quality of the link at the second time instance that occurs after the first time instance and the UE 2102 may transmit the indication of the future quality of the link to the server 2104. Furthermore, at 2028, the server 2104 may obtain a confidence level of the future quality of the link. In one example, at the first time instance, the server 2104 may estimate the confidence level. In another example, at the first time instance, the server 2104 may receive an indication of the confidence level from the UE 2102.

At 2130, the server 2104 may obtain a split-compute configuration between the first set of application functions and the second set of application functions based on the estimated quality of the link. In one example, the server 2104 may select the split-compute configuration (e.g., from amongst many different split-compute configurations) based on the estimated quality of the link. In another example, the UE 2102 may select the split-compute configuration (e.g., from amongst many different split-compute configurations) based on the estimated quality of the link and the UE 2102 may transmit an indication of the split-compute configuration to the server 2104. In some aspects, the server 2104 may obtain the split-compute configuration additionally based on the future quality of the link, the performance metric(s), and/or the corresponding qualities of link(s) for split-compute configuration(s).

At 2132, the server 2104 may output an indication of the obtained split-compute configuration. For instance, at 2134, the server 2104 may transmit an indication of the split-compute configuration to the UE 2102. At 2136, the server 2104 may execute the second executable based on the split-compute configuration obtained at 2130. Although the second executable is illustrated in the diagram as being executed after 2122, 2124, 2126, 2128, 2130, 2132, and 2134, the second executable may be executed concurrently with performance of 2122, 2124, 2126, 2128, 2130, 2132, and 2134. At 2138, the UE 2102 may execute the first executable based on the split-compute configuration. Execution of the first executable and the second executable may cause graphical data (e.g., UE-rendered media and/or server-rendered media) to be displayed on a display of the UE 2102.

In one aspect, at 2140, the UE 2102 may determine that server-rendered media is to be utilized based on the split-compute configuration. At 2142, the UE 2102 may transmit a request for the server rendered media to the server 2104. At 2144, the server 2104 may compute and transmit the server-rendered media to the UE 2102 based on receiving the request and the split-compute configuration. Alternatively, the server 2104 may transmit, based on the split-compute configuration, the server-rendered media to the UE 2102 without receiving a request from the UE 2102. In an example, the UE 2102 may present the server-rendered media on the display of the UE 2102.

In one aspect, at 2146, the UE 2102 may compute UE-rendered media based on the split-compute configuration. The UE 2102 may present the UE-rendered media on the display of the UE 2102. In an example, the UE 2102 may present the UE-rendered media concurrently with the server-rendered media. For instance, the server-rendered media may be media that is computationally intensive to render (e.g., ray-traced graphics) and the UE-rendered media may be media that is less computationally intensive to render compared to the server-rendered media. At 2148, the UE 2102 may select the UE-rendered media or the server-rendered media based on a swapchain. The UE 2102 may then present the selected media on the display.

At 2150, the server 2104 may obtain an updated estimated quality of the link between the UE 2102 and the server 2104 at a time instance occurring after 2122. In one example, the server 2104 may estimate the updated quality of the link. In another example, the UE 2102 may estimate the updated quality of the link and the UE 2102 may transmit an indication of the updated estimated quality of the link to the server 2104.

At 2152, the server 2104 may obtain a second split-compute configuration based on the updated estimated quality of the link. In one example, the server 2104 may select the second split-compute configuration (e.g., from amongst many different split-compute configurations) based on the updated estimated quality of the link. In another example, the UE 2102 may select the second split-compute configuration (e.g., from amongst many different split-compute configurations) based on the updated estimated quality of the link and the UE 2102 may transmit an indication of the second split-compute configuration to the server 2104. At 2154, the server 2104 may transmit an indication of the second split-compute configuration to the UE 2102. Alternatively, at 2154, the server 2104 may transmit an indication that indicates that the UE 2102 is to select a second split-compute configuration or that the UE 2102 is to rate-adapt information associated with the application.

In one aspect, at 2156, the server 2104 may receive, from the UE 2102, an indication that the server 2104 is to select the second split-compute configuration or that the server 2104 is to rate-adapt (e.g., change a bitrate of) information associated with the application. In one aspect at 2158, the server 2104 may establish a session with an application server for the application, obtain, from the application server and during the session, state information for the application and/or media information for the application, and synchronize with the UE 2102 based on the state information and/or the media information.

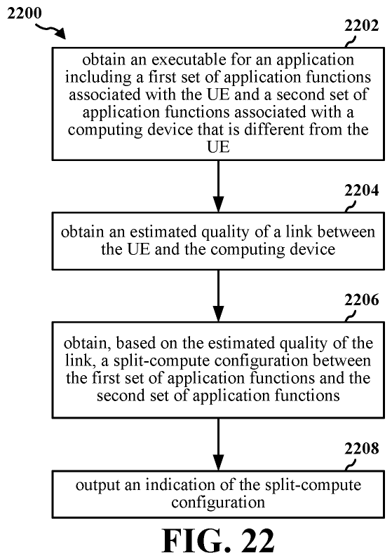

FIG. 22 is a flowchart 2200 of an example method of graphics processing in accordance with one or more techniques of this disclosure. The method may be performed by an apparatus, such as an apparatus for graphics processing, a GPU, a CPU, a wireless communication device, and the like, as used in connection with the aspects of FIGS. 1-4, FIG. 5A, FIG. 5B, FIG. 5C, FIG. 5D, and FIGS. 6-21. In an example, the method may be performed by the device split-compute orchestrator 198.

At 2202, the apparatus (e.g., the device 104) obtains an executable for an application including a first set of application functions associated with the UE and a second set of application functions associated with a computing device that is different from the UE. For example, FIG. 20 at 2018 shows that the UE 2002 may obtain a first executable. In an example, the executable may be the device executable 1406. In an example, 2202 may be performed by the device split-compute orchestrator 198.

At 2204, the apparatus (e.g., the device 104) obtains an estimated quality of a link between the UE and the computing device. For example, FIG. 20 at 2022 shows that the UE 2002 may obtain an estimated quality of a link between the UE 2002 and the server 2004. In an example, 2204 may be performed by the device split-compute orchestrator 198.

At 2206, the apparatus (e.g., the device 104) obtains, based on the estimated quality of the link, a split-compute configuration between the first set of application functions and the second set of application functions. For example, FIG. 20 at 2030 shows that the UE 2002 may obtain a split-compute configuration based on an estimated quality of the link between the UE 2002 and the server 2004. In an example, 2206 may be performed by the device split-compute orchestrator 198.

At 2208, the apparatus (e.g., the device 104) outputs an indication of the split-compute configuration. For example, FIG. 20 at 2032 shows that the UE 2002 may output an indication of the split-compute configuration. In an example, 2208 may be performed by the device split-compute orchestrator 198.

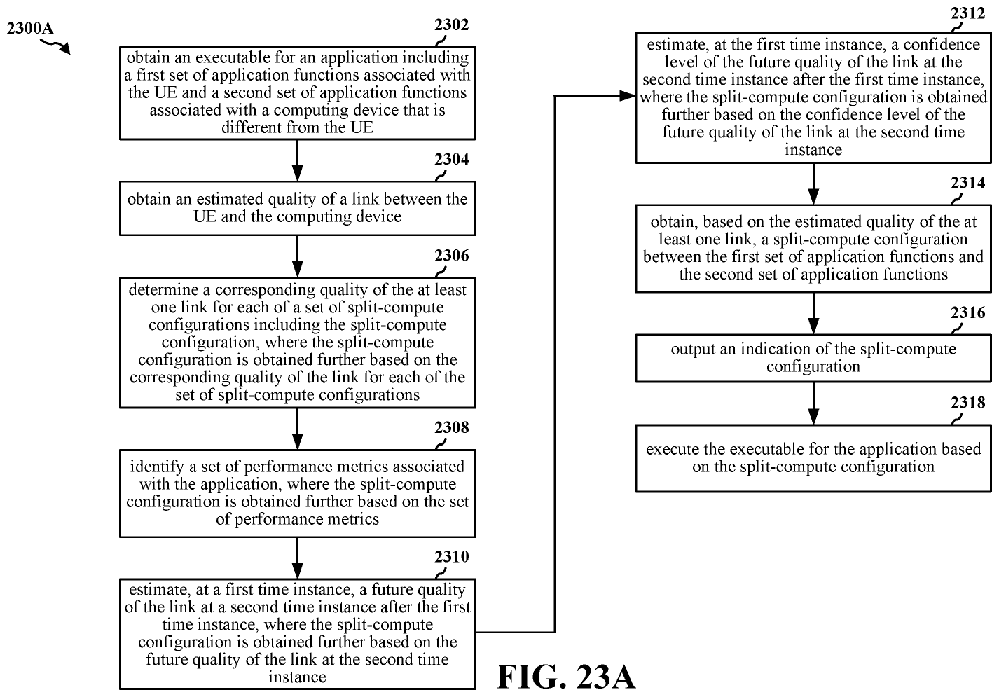

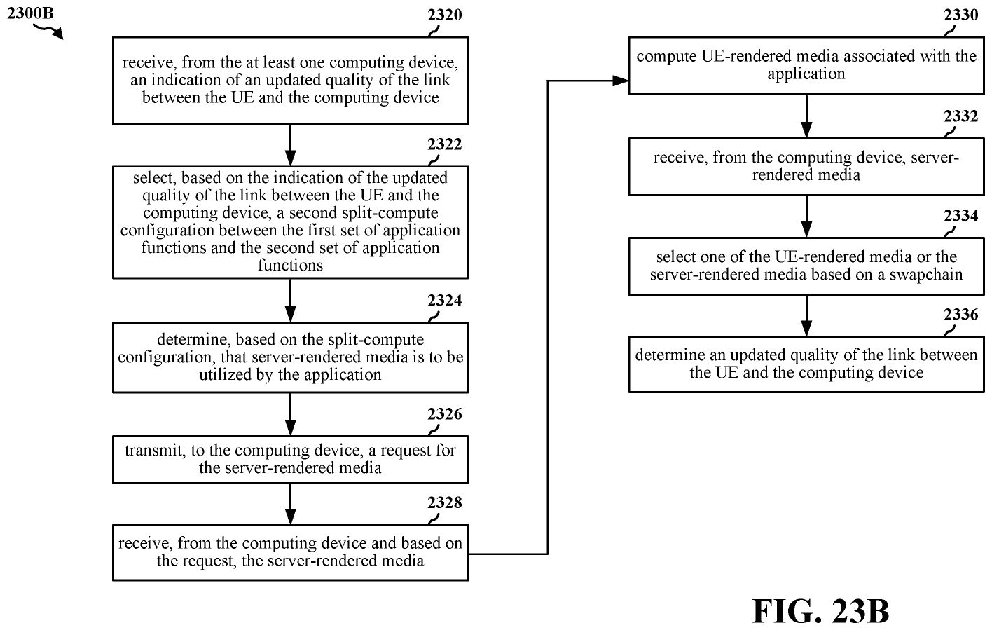

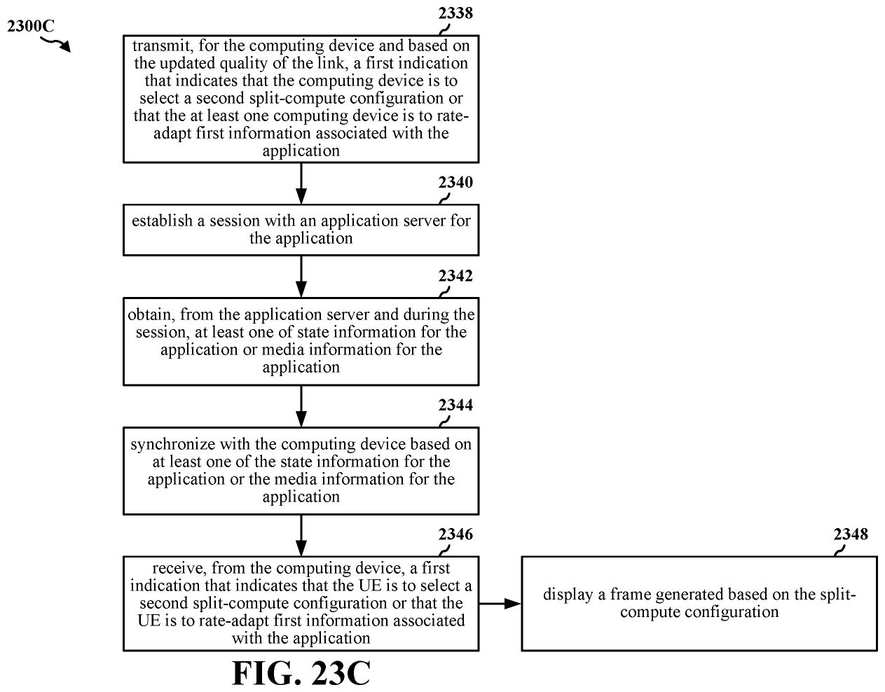

FIG. 23A is a flowchart 2300A of an example method of graphics processing in accordance with one or more techniques of this disclosure. FIG. 23B is a flowchart 2300B of an example method of graphics processing in accordance with one or more techniques of this disclosure. FIG. 23C is a flowchart 2300C of an example method of graphics processing in accordance with one or more techniques of this disclosure. The method may be performed by an apparatus, such as an apparatus for graphics processing, a GPU, a CPU, a wireless communication device, and the like, as used in connection with the aspects of FIGS. 1-4, FIG. 5A, FIG. 5B, FIG. 5C, FIG. 5D, and FIGS. 6-21. In an example, the method (including the various aspects detailed below) may be performed by the device split-compute orchestrator 198.

At 2302, the apparatus (e.g., the device 104) obtains an executable for an application including a first set of application functions associated with the UE and a second set of application functions associated with a computing device that is different from the UE. For example, FIG. 20 at 2018 shows that the UE 2002 may obtain a first executable. In an example, the executable may be the device executable 1406. In an example, 2302 may be performed by the device split-compute orchestrator 198.

At 2304, the apparatus (e.g., the device 104) obtains an estimated quality of link between the UE and the computing device. For example, FIG. 20 at 2022 shows that the UE 2002 may obtain an estimated quality of a link between the UE 2002 and the server 2004. In an example, 2304 may be performed by the device split-compute orchestrator 198.

At 2314, the apparatus (e.g., the device 104) obtains, based on the estimated quality of the link, a split-compute configuration between the first set of application functions and the second set of application functions. For example, FIG. 20 at 2030 shows that the UE 2002 may obtain a split-compute configuration based on an estimated quality of the link between the UE 2002 and the server 2004. In an example, 2314 may be performed by the device split-compute orchestrator 198.

At 2316, the apparatus (e.g., the device 104) outputs an indication of the split-compute configuration. For example, FIG. 20 at 2032 shows that the UE 2002 may output an indication of the split-compute configuration. In an example, 2316 may be performed by the device split-compute orchestrator 198.

In one aspect, obtaining the estimated quality of the link may include estimating a quality of the link between the UE and the computing device, and obtaining the split-compute configuration may include selecting, based on the estimated quality of the link, the split-compute configuration. For example, obtaining the estimated quality of the link at 2022 may include estimating a quality of the link between the UE and the server 2004 and obtaining the split-compute configuration at 2030 may include selecting, based on the estimated quality of the link, the split-compute configuration.

In one aspect, obtaining the estimated quality of the link may include receiving, from the computing device, an indication of the estimated quality of the link, and obtaining the split-compute configuration may include selecting, based on the indication of the estimated quality of the link, the split-compute configuration. For example, obtaining the estimated quality of the link at 2022 may include receiving, from the server 2004, an indication of the estimated quality of the link and obtaining the split-compute configuration at 2030 may include selecting, based on the indication of the estimated quality of the link, the split-compute configuration.

In one aspect, obtaining the estimated quality of the link may include estimating a quality of the link between the UE and the computing device, and obtaining the split-compute configuration may include: transmitting, for the computing device, an indication of the estimated quality of the link. For example, obtaining the estimated quality of the link at 2022 may include estimating a quality of the link between the UE 2002 and the server 2004 and obtaining the split-compute configuration at 2030 may include transmitting, for the server 2004, an indication of the estimated quality of the link.

In one aspect, obtaining the split-compute configuration may include receiving, from the computing device and based on the indication of the estimated quality of the link, the split-compute configuration. For example, obtaining the estimated quality of the link at 2022 may include receiving, from the server 2004 and based on the indication of the estimated quality of the link, the split-compute configuration

In one aspect, at 2318, the apparatus (e.g., the device 104) may execute the executable for the application based on the split-compute configuration. For example, FIG. 20 at 2036 shows that the UE 2002 may execute the first executable based on the split-compute configuration. In an example, 2318 may be performed by the device split-compute orchestrator 198.

In one aspect, at 2320, the apparatus (e.g., the device 104) may receive, from the computing device, an indication of an updated quality of the link between the UE and the computing device. For example, FIG. 20 at 2050 shows that the UE 2002 may receive, from the server 2004, an indication of an updated quality of the link between the UE 2002 and the server 2004. In an example, 2320 may be performed by the device split-compute orchestrator 198.

In one aspect, at 2322, the apparatus (e.g., the device 104) may select, based on the indication of the updated quality of the link between the UE and the computing device, a second split-compute configuration between the first set of application functions and the second set of application functions. For example, FIG. 20 at 2052 shows that the UE 2002 may select a second split-compute configuration. In an example, 2322 may be performed by the device split-compute orchestrator 198.

In one aspect, at 2306, the apparatus (e.g., the device 104) may determine a corresponding quality of the link for each of a set of split-compute configurations including the split-compute configuration, where the split-compute configuration may be obtained further based on the corresponding quality of the link for each of the set of split-compute configurations. For example, FIG. 20 at 2026 shows that the UE 2002 may determine qualities of link(s) for split-compute configuration(s). In an example, 2306 may be performed by the device split-compute orchestrator 198.

In one aspect, the quality of the link between the UE and the computing device may be based on: power consumed by the UE during execution of the application, a set of power consumption characteristics of at least one of a transceiver or an antenna of the UE, a time period to understand a channel associated with the link, a current channel capacity (e.g., a current link capacity) associated with the link, or a future channel capacity associated with the link. For example, FIG. 10 shows that the quality of the link between the UE and the at least one server may be based on: power consumed by the UE during execution of the application, a set of power consumption characteristics of at least one of a transceiver or an antenna of the UE, a time period to understand a channel associated with the link, a current channel capacity associated with the link, or a future channel capacity associated with the link.

In one aspect, the link may include at least one of a RAN link or a WLAN link. For example, FIG. 9 shows that the link may include at least one of a RAN link or a WLAN link.

In one aspect, at 2308, the apparatus (e.g., the device 104) may identify a set of performance metrics (e.g., frame rate, image quality, motion-to-render-to-photon-latency) associated with the application, where the split-compute configuration may be obtained further based on the set of performance metrics. For example, FIG. 20 at 2024 shows that the UE 2002 may identify performance metric(s) associated with the application. In an example, 2308 may be performed by the device split-compute orchestrator 198.

In one aspect, the split-compute configuration may maintain the set of performance metrics while minimizing a power consumption of the UE. For example, the split-compute configuration obtained at 2030 may maintain the performance metric(s) identified at 2024 while minimizing a power consumption of the UE 2002.

In one aspect, the set of performance metrics may include at least one of a frame rate of the application, a display resolution of the application, or an operational state of the application. For example, the performance metric(s) identified at 2024 may include at least one of a frame rate of the application, a display resolution of the application, or an operational state of the application.

In one aspect, at 2310, the apparatus (e.g., the device 104) may estimate, at a first time instance, a future quality of the link at a second time instance after the first time instance, where the split-compute configuration may be obtained further based on the future quality of the link at the second time instance. For example, FIG. 20 at 2028 shows that the UE 2002 may estimate, at a first time instance, a future quality of the link at a second time instance after the first time instance, where the split-compute configuration may be obtained further based on the future quality of the link at the second time instance. In an example, 2310 may be performed by the device split-compute orchestrator 198.

In one aspect, at 2312, the apparatus (e.g., the device 104) may estimate, at the first time instance, a confidence level of the future quality of the link at the second time instance after the first time instance, where the split-compute configuration may be obtained further based on the confidence level of the future quality of the link at the second time instance. For example, FIG. 20 at 2028 shows that the UE 2002 may estimate, at the first time instance, a confidence level of the future quality of the link at the second time instance after the first time instance, where the split-compute configuration may be obtained further based on the confidence level of the future quality of the link at the second time instance. In an example, 2312 may be performed by the device split-compute orchestrator 198.

In one aspect, outputting the indication of the split-compute configuration may include at least one of: transmitting the indication of the split-compute configuration to the at least one server or storing the indication of the split-compute configuration in at least one of a memory or a cache. For example, outputting the indication of the spilt-compute configuration at 2032 may include transmitting the indication of the split-compute configuration to the server 2004 or storing the indication of the split-compute configuration in at least one of a memory or a cache.

In one aspect, at 2324, the apparatus (e.g., the device 104) may determine, based on the split-compute configuration, that server-rendered media is to be utilized by the application. For example, FIG. 20 at 2040 shows that the UE 2002 may determine, based on the split-compute configuration, that server-rendered media is to be utilized by the application. In an example, 2324 may be performed by the device split-compute orchestrator 198.

In one aspect, at 2326, the apparatus (e.g., the device 104) may transmit, to the computing device, a request for the server-rendered media. For example, FIG. 20 at 2042 shows that the UE 2002 may transmit, to the server 2004, a request for the server-rendered media. In an example, 2326 may be performed by the device split-compute orchestrator 198.

In one aspect, at 2328, the apparatus (e.g., the device 104) may receive, from the computing device and based on the request, the server-rendered media. For example, FIG. 20 at 2044 shows that the UE 2002 may receive server-rendered media. In an example, 2328 may be performed by the device split-compute orchestrator 198.

In one aspect, at 2330, the apparatus (e.g., the device 104) may compute UE-rendered media associated with the application. For example, FIG. 20 at 2046 shows that the UE 2002 may compute UE-rendered media. For example, FIG. 18 shows that a UE may compute UE-rendered media associated with the application. In an example, 2330 may be performed by the device split-compute orchestrator 198.

In one aspect, at 2332, the apparatus (e.g., the device 104) may receive, from the computing device, server-rendered media. For example, FIG. 20 at 2044 shows that the UE 2002 may receive server-rendered media. For example, FIG. 18 shows that a UE may receive, from at least one server, server-rendered media. In an example, 2332 may be performed by the device split-compute orchestrator 198.

In one aspect, at 2334, the apparatus (e.g., the device 104) may select one of the UE-rendered media or the server-rendered media based on a swapchain. For example, FIG. 20 at 2048 shows that the UE 2002 may select one of the UE-rendered media based on a swapchain. For example, FIG. 18 shows that a UE may select one of the UE-rendered media or the server-rendered media based on a swapchain. In an example, 2334 may be performed by the device split-compute orchestrator 198.

In one aspect, the UE may include a first type of graphics processor and the at least one server may include a second type of graphics processor, where at least one performance attribute of the second type of graphics processor is greater than the first type of graphics processor. For example, the UE 2002 may include a first type of graphics processor and the server 2004 may include a second type of graphics processor, where at least one performance attribute of the second type of graphics processor is greater than the first type of graphics processor.

In one aspect, the first set of application functions may include at least one of a first game engine, first media codecs, first metadata, or first game state transfer information between the UE and the computing device, and the second set of application functions may include at least one of a second game engine, second media codes, second metadata, and second game state transfer information between the computing device and the UE. For example, the first set of application functions may be or include the first codecs, metadata, and game state transfer information 1424 and the device GE rendering functions 1426 and the second set of application functions may be or include the second codecs, metadata, and game state transfer information 1436 and the edge GE rendering functions 1438.

In one aspect, at 2336, the apparatus (e.g., the device 104) may determine an updated quality of the link between the UE and the computing device. For example, FIG. 20 at 2050 shows that the UE 2002 may determine an updated quality of the link between the UE and the server 2004. In an example, 2336 may be performed by the device split-compute orchestrator 198.

In one aspect, at 2338, the apparatus (e.g., the device 104) may transmit, for the computing device and based on the updated quality of the link, a first indication that indicates that the computing device is to select a second split-compute configuration or that the computing device is to rate-adapt first information associated with the application. For example, FIG. 20 at 2054 shows that the UE 2002 may transmit, for the server 2004, a first indication that indicates that the server 2004 is to select a second split-compute configuration or that the server 2004 is to rate-adapt first information associated with the application. In an example, 2338 may be performed by the device split-compute orchestrator 198.

In one aspect, at 2340 the apparatus (e.g., the device 104) may establish a session with an application server for the application. For example, FIG. 20 at 2058 shows that the UE 2002 may establish a session with an application server for the application. In an example, the application server may be the central application server 1714. In an example, 2340 may be performed by the device split-compute orchestrator 198.

In one aspect, at 2342, the apparatus (e.g., the device 104) may obtain, from the application server and during the session, at least one of state information for the application or media information for the application. For example, FIG. 20 at 2058 shows that the UE 2002 may obtain, from the application server and during the session, at least one of state information for the application or media information for the application. In an example, 2342 may be performed by the device split-compute orchestrator 198.

In one aspect, at 2344, the apparatus (e.g., the device 104) may synchronize with the computing device based on at least one of the state information for the application or the media information for the application. For example, FIG. 20 at 2058 shows that the UE 2002 may synchronize with the server 2004 based on at least one of the state information for the application or the media information for the application. In an example, 2344 may be performed by the device split-compute orchestrator 198.

In one aspect, at 2346, the apparatus (e.g., the device 104) may receive, from the computing device, a first indication that indicates that the UE is to select a second split-compute configuration or that the UE is to rate-adapt first information associated with the application. For example, FIG. 20 at 2056 shows that the UE 2002 may receive, from the server 2004, a first indication that indicates that the UE 2002 is to select a second split-compute configuration or that the UE 2002 is to rate-adapt first information associated with the application. In an example, 2346 may be performed by the device split-compute orchestrator 198.

In one aspect, at 2348, the apparatus (e.g., the device 104) may display a frame generated based on the split-compute configuration. For instance, FIG. 20 at 2060 shows that the UE 2102 may display a frame generated based on a split-compute configuration. For example, 2348 may be performed by the device split-compute orchestrator 198.

In one aspect, the computing device may include at least one server. For instance, the computing device may include the server 2104.

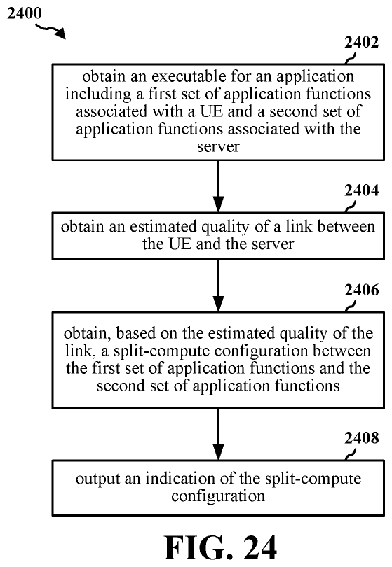

FIG. 24 is a flowchart 2400 of an example method of graphics processing in accordance with one or more techniques of this disclosure. The method may be performed by an apparatus, such as an apparatus for graphics processing, a GPU, a CPU, a wireless communication device, and the like, as used in connection with the aspects of FIGS. 1-4, FIG. 5A, FIG. 5B, FIG. 5C, FIG. 5D, and FIGS. 6-21. In an example, the method may be performed by the edge orchestration manager 1433.

At 2402, the apparatus (e.g., the edge 1518) obtains an executable for an application including a first set of application functions associated with a UE and a second set of application functions associated with the server. For example, FIG. 21 at 2118 shows that the server 2104 may obtain a second executable for an application including a first set of application functions associated with a UE and a second set of application functions associated with the server. In an example, the executable may be the edge executable 1408. In an example, 2402 may be performed by the edge orchestration manager 1433.

At 2404, the apparatus (e.g., the edge 1518) obtains an estimated quality of a link between the UE and the server. For example, FIG. 21 at 2122 shows that the server 2104 may obtain an estimated quality of a link between the UE and the server. In an example, 2404 may be performed by the edge orchestration manager 1433.

At 2406, the apparatus (e.g., the edge 1518) obtains, based on the estimated quality of the link, a split-compute configuration between the first set of application functions and the second set of application functions. For example, FIG. 21 at 2130 shows that the server 2104 may obtain, based on the estimated quality of the link, a split-compute configuration between the first set of application functions and the second set of application functions. In an example, 2406 may be performed by the edge orchestration manager 1433.

At 2408, the apparatus (e.g., the edge 1518) outputs an indication of the split-compute configuration. For example, FIG. 21 at 2132 shows that the server 2104 may output an indication of the split-compute configuration. In an example, 2408 may be performed by the edge orchestration manager 1433.

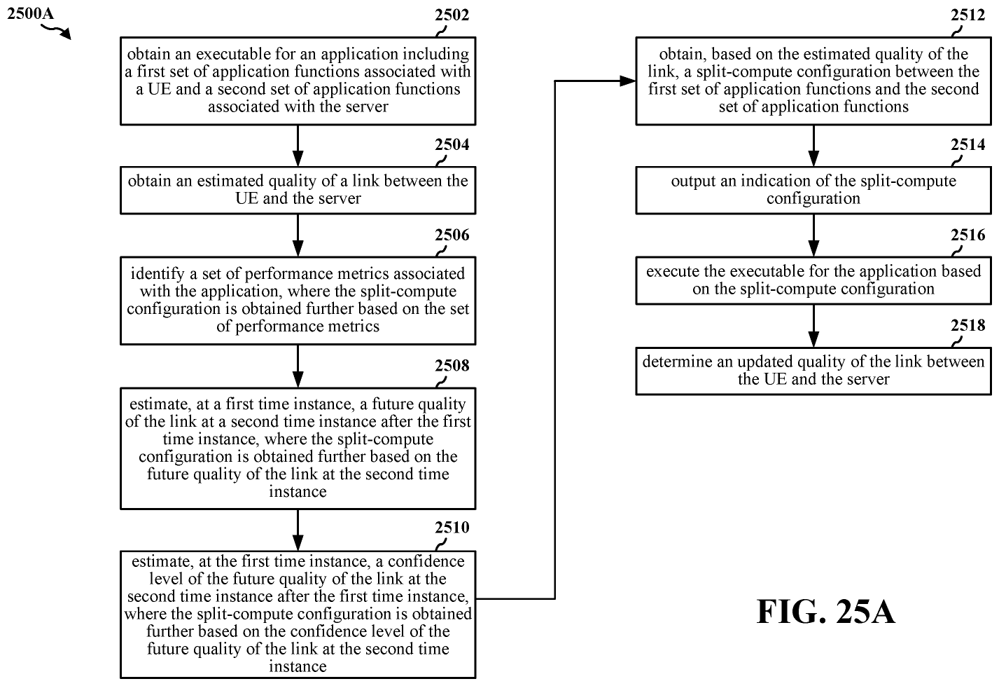

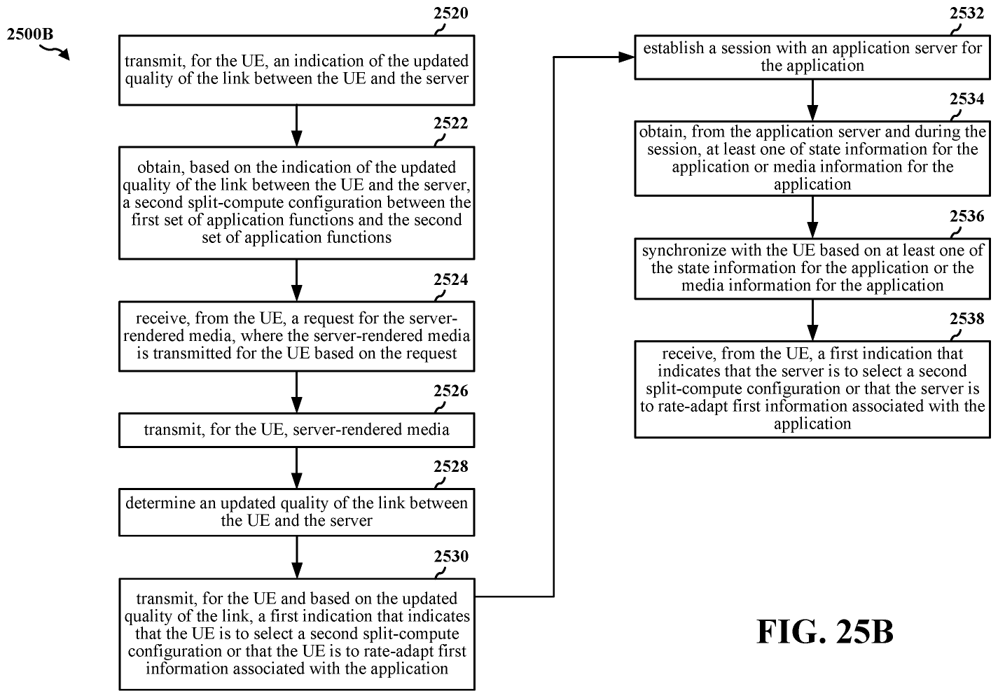

FIG. 25A is a flowchart 2500A of an example method of graphics processing in accordance with one or more techniques of this disclosure. FIG. 25B is a flowchart 2500B of an example method of graphics processing in accordance with one or more techniques of this disclosure. The method may be performed by an apparatus, such as an apparatus for graphics processing, a GPU, a CPU, a wireless communication device, and the like, as used in connection with the aspects of FIGS. 1-4, FIG. 5A, FIG. 5B, FIG. 5C, FIG. 5D, and FIGS. 6-21. In an example, the method (including the various aspects detailed below) may be performed by the edge orchestration manager 1433.

At 2502, the apparatus (e.g., the edge 1518) obtains an executable for an application including a first set of application functions associated with a UE and a second set of application functions associated with the server. For example, FIG. 21 at 2118 shows that the server 2104 may obtain a second executable for an application including a first set of application functions associated with a UE and a second set of application functions associated with the server. In an example, the executable may be the edge executable 1408. In an example, 2502 may be performed by the edge orchestration manager 1433.

At 2504, the apparatus (e.g., the edge 1518) obtains an estimated quality of a link between the UE and the server. For example, FIG. 21 at 2122 shows that the server 2104 may obtain an estimated quality of a link between the UE and the server. In an example, 2504 may be performed by the edge orchestration manager 1433.

At 2512, the apparatus (e.g., the edge 1518) obtains, based on the estimated quality of the link, a split-compute configuration between the first set of application functions and the second set of application functions. For example, FIG. 21 at 2130 shows that the server 2104 may obtain, based on the estimated quality of the link, a split-compute configuration between the first set of application functions and the second set of application functions. In an example, 2512 may be performed by the edge orchestration manager 1433.

At 2514, the apparatus (e.g., the edge 1518) outputs an indication of the split-compute configuration. For example, FIG. 21 at 2132 shows that the server 2104 may output an indication of the split-compute configuration. In an example, 2514 may be performed by the edge orchestration manager 1433.

In one aspect, obtaining the estimated quality of the link may include estimating a quality of the link between the UE and the server, and obtaining the split-compute configuration may include selecting, based on the estimated quality of the link, the split-compute configuration. For example, obtaining the estimated quality of the link at 2122 may include estimating a quality of the link between the UE 2102 and the server 2104 and obtaining the split-compute configuration at 2130 may include selecting, based on the estimated quality of the link, the split-compute configuration.

In one aspect, obtaining the estimated quality of the link may include receiving, from the UE, an indication of the estimated quality of the link, and obtaining the split-compute configuration may include selecting, based on the indication of the estimated quality of the link, the split-compute configuration. For example, obtaining the estimated quality of the link at 2122 may include receiving, from the UE 2102, an indication of the estimated quality of the link and obtaining the split-compute configuration at 2130 may include selecting, based on the indication of the estimated quality of the link, the split-compute configuration.

In one aspect, obtaining the estimated quality of the link may include estimating a quality of the link between the UE and the server, and obtaining the split-compute configuration may include: transmitting, for the UE, an indication of the estimated quality of the link. For example, obtaining the estimated quality of the link at 2122 may include estimating a quality of the link between the UE 2102 and the server 2104 and obtaining the split-compute configuration at 2130 may include transmitting, for the UE 2102, an indication of the estimated quality of the link.

In one aspect, obtaining the split-compute configuration may include receiving, from the UE and based on the indication of the estimated quality of the link, the split-compute configuration. For example, obtaining the split-compute configuration at 2130 may include receiving, from the UE 2102 and based on the indication of the estimated quality of the link, the split-compute configuration.

In one aspect, at 2516 the apparatus (e.g., the edge 1518) may execute the executable for the application based on the split-compute configuration. For example, FIG. 21 at 2136 shows that the server 2104 may execute the second executable based on the split-compute configuration. In an example, 2516 may be performed by the edge orchestration manager 1433.

In one aspect, at 2518, the apparatus (e.g., the edge 1518) may determine an updated quality of the link between the UE and the server. For example, FIG. 21 at 2150 shows that the server 2104 may determine an updated quality of the link between the UE 2102 and the server 2104. In an example, 2518 may be performed by the edge orchestration manager 1433.

In one aspect, at 2520, the apparatus (e.g., the edge 1518) may transmit, for the UE, an indication of the updated quality of the link between the UE and the server. For example, the server 2104 may transmit, for the UE 2102 an indication of the updated quality of the link between the UE 2102 and the server 2104. In an example, 2520 may be performed by the edge orchestration manager 1433.

In one aspect, at 2522, the apparatus (e.g., the edge 1518) may obtain, based on the indication of the updated quality of the link between the UE and the server, a second split-compute configuration between the first set of application functions and the second set of application functions. For example, FIG. 21 at 2152 shows that the server 2104 may obtain, based on the indication of the updated quality of the link between the UE 2102 and the server 2104, a second split-compute configuration between the first set of application functions and the second set of application functions. In an example, 2522 may be performed by the edge orchestration manager 1433.

In one aspect, the link may include at least one of a RAN link or a WLAN link. For example, FIG. 9 shows that the link may include a RAN link or a WLAN link.

In one aspect, at 2506, the apparatus (e.g., the edge 1518) may identify a set of performance metrics associated with the application, where the split-compute configuration may be obtained further based on the set of performance metrics. For example, FIG. 21 at 2124 shows that the server 2104 may identify performance metric(s). In an example, 2506 may be performed by the edge orchestration manager 1433.

In one aspect, the split-compute configuration may maintain the set of performance metrics while minimizing a power consumption of the UE. For example, the split-compute configuration obtained at 2130 may maintain the set of performance metrics while minimizing a power consumption of the UE 2102.

In one aspect, the set of performance metrics may include at least one of a frame rate of the application, a display resolution of the application, or an operational state of the application. For example, the performance metric(s) identified at 2124 may include at least one of a frame rate of the application, a display resolution of the application, or an operational state of the application.

In one aspect, at 2508, the apparatus (e.g., the edge 1518) may estimate, at a first time instance, a future quality of the link at a second time instance after the first time instance, where the split-compute configuration may be obtained further based on the future quality of the link at the second time instance. For example, FIG. 21 at 2128 shows that the server 2104 may estimate, at a first time instance, a future quality of a link at a second time instance after the first time instance. In an example, 2508 may be performed by the edge orchestration manager 1433.

In one aspect, at 2510, the apparatus (e.g., the edge 1518) may estimate, at the first time instance, a confidence level of the future quality of the link at the second time instance after the first time instance, where the split-compute configuration may be obtained further based on the confidence level of the future quality of the link at the second time instance. For example, FIG. 21 at 2128 shows that the server 2104 may estimate a confidence level of the future quality of the link at the second time instance after the first time instance. In an example, 2510 may be performed by the edge orchestration manager 1433.

In one aspect, outputting the indication of the split-compute configuration may include at least one of: transmitting the indication of the split-compute configuration to the UE or storing the indication of the split-compute configuration in at least one of a memory or a cache. For example, outputting the indication of the split-compute configuration at 2132 may include transmitting the indication of the split-compute configuration to the UE 2102 or storing the indication of the split-compute configuration in at least one of a memory or a cache

In one aspect, at 2526, the apparatus (e.g., the edge 1518) may transmit, for the UE, server-rendered media. For example, FIG. 21 at 2144 shows that the server 2104 may transmit server-rendered media for the UE 2102. In an example, 2526 may be performed by the edge orchestration manager 1433.

In one aspect, at 2524, the apparatus (e.g., the edge 1518) may receive, from the UE, a request for the server-rendered media, where the server-rendered media may be transmitted for the UE based on the request. For example, FIG. 21 at 2142 shows that the server 2104 may receive a request for server-rendered media. In an example, 2524 may be performed by the edge orchestration manager 1433.

In one aspect, the UE may include a first type of graphics processor and the server may include a second type of graphics processor, where at least one performance attribute of the second type of graphics processor is greater than the first type of graphics processor. For example, the UE 2102 may include a first type of graphics processor and the server 2104 may include a second type of graphics processor, where at least one performance attribute of the second type of graphics processor is greater than the first type of graphics processor.

In one aspect, the first set of application functions may include at least one of a first game engine, first media codecs, first metadata, or first game state transfer information between the UE and the server, and the second set of application functions may include at least one of a second game engine, second media codes, second metadata, and second game state transfer information between the server and the UE. For example, the first set of application functions may be or include the first codecs, metadata, and game state transfer information 1424 and the device GE rendering functions 1426 and the second set of application functions may be or include the second codecs, metadata, and game state transfer information 1436 and the edge GE rendering functions 1438.

In one aspect, at 2528, the apparatus (e.g., the edge 1518) may determine an updated quality of the link between the UE and the server. For example, FIG. 21 at 2150 shows that the server 2104 may determine an updated quality of the link between the UE 2102 and the server 2104. In an example, 2528 may be performed by the edge orchestration manager 1433.

In one aspect, at 2530, the apparatus (e.g., the edge 1518) may transmit, for the UE and based on the updated quality of the link, a first indication that indicates that the UE is to select a second split-compute configuration or that the UE is to rate-adapt first information associated with the application. For example, FIG. 21 at 2154 shows that the server 2104 may transmit a first indication that indicates that the UE is to select a second split-compute configuration or that the UE is to rate-adapt first information associated with the application. In an example, 2530 may be performed by the edge orchestration manager 1433.

In one aspect, at 2532, the apparatus (e.g., the edge 1518) may establish a session with an application server for the application. For example, FIG. 21 at 2158 shows that the server 2104 may establish a session with an application server for the application. In an example, the application server may be the central application server 1714. In an example, 2532 may be performed by the edge orchestration manager 1433.

In one aspect, at 2534, the apparatus (e.g., the edge 1518) may obtain, from the application server and during the session, at least one of state information for the application or media information for the application. For example, FIG. 21 at 2158 shows that the server 2104 may obtain, from the application server and during the session, at least one of state information for the application or media information for the application. In an example, 2534 may be performed by the edge orchestration manager 1433.

In one aspect, at 2536, the apparatus (e.g., the edge 1518) may synchronize with the UE based on at least one of the state information for the application or the media information for the application. For example, FIG. 21 at 2158 shows that the server 2104 may synchronize with the UE 2102 based on at least one of the state information for the application or the media information for the application. In an example, 2536 may be performed by the edge orchestration manager 1433.

In one aspect, at 2538, the apparatus may receive, from the UE, a first indication that indicates that the server is to select a second split-compute configuration or that the server is to rate-adapt first information associated with the application. For example, FIG. 21 at 2156 shows that the server 2104 may receive an indication that indicates that the server 2104 is to select a second split-compute configuration or that the server 2104 is to rate-adapt first information associated with the application. In an example, 2538 may be performed by the edge orchestration manager 1433.

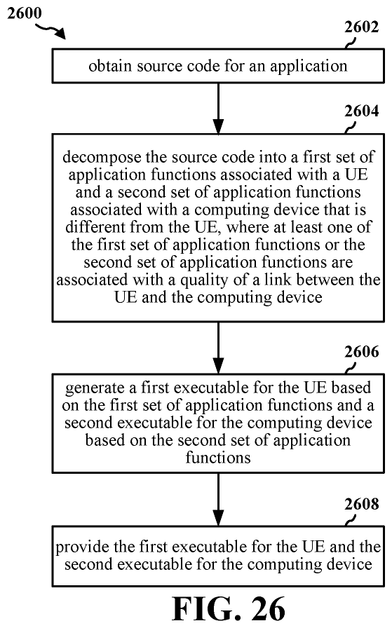

FIG. 26 is a flowchart 2600 of an example method of graphics processing in accordance with one or more techniques of this disclosure. The method may be performed by an apparatus, such as an apparatus for graphics processing, a GPU, a CPU, a wireless communication device, and the like, as used in connection with the aspects of FIGS. 1-4, FIG. 5A, FIG. 5B, FIG. 5C, FIG. 5D, and FIGS. 6-21. In an example, the method may be performed by the split-compute compiler 1404 and/or the developer computing device 1502.

At 2602, the apparatus (e.g., the developer computing device 1502) obtains source code for an application. For example, FIG. 20 at 2008 shows that the developer computing device 2006 may obtain source code for an application. In an example, the source code may be or include the application source code 1410. In an example, 2602 may be performed by the split-compute compiler 1404 and/or the developer computing device 1502.

At 2604, the apparatus (e.g., the developer computing device 1502) decomposes the source code into a first set of application functions associated with a UE and a second set of application functions associated with a computing device that is different from the UE, where at least one of the first set of application functions or the second set of application functions are associated with a quality of a link between the UE and the computing device. For example, FIG. 20 at 2010 shows that the developer computing device 2006 may decompose the source code into a first set of application functions associated with the UE 2002 and a second set of application functions associated with the server 2004. In an example, 2604 may be performed by the split-compute compiler 1404 and/or the developer computing device 1502.

At 2606, the apparatus (e.g., the developer computing device 1502) generates a first executable for the UE based on the first set of application functions and a second executable for the computing device based on the second set of application functions. For example, FIG. 20 at 2012 shows that the developer computing device 2006 may generate a first executable for the UE 2002 based on the first set of application functions and a second executable for the server 2004 based on the second set of application functions. In an example, 2606 may be performed by the split-compute compiler 1404 and/or the developer computing device 1502.

At 2608, the apparatus (e.g., the developer computing device 1502) provides the first executable for the UE and the second executable for the computing device. For example, FIG. 20 at 2014 shows that the developer computing device 2006 may provide the first executable for the UE 2002 and FIG. 20 at 2016 shows that the developer computing device 2006 may provide the second executable for the server 2004. In an example, 2608 may be performed by the split-compute compiler 1404 and/or the developer computing device 1502.

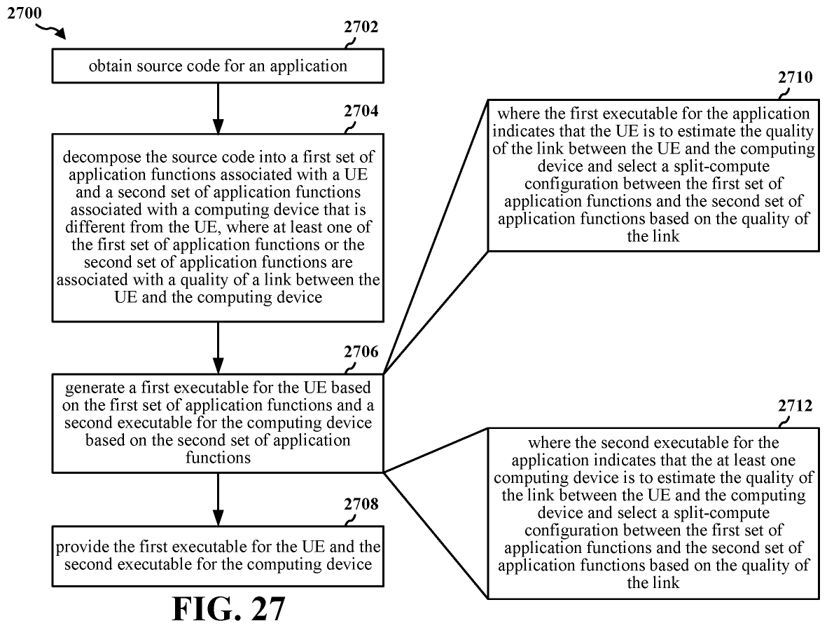

FIG. 27 is a flowchart 2700 of an example method of graphics processing in accordance with one or more techniques of this disclosure. The method may be performed by an apparatus, such as an apparatus for graphics processing, a GPU, a CPU, a wireless communication device, and the like, as used in connection with the aspects of FIGS. 1-4, FIG. 5A, FIG. 5B, FIG. 5C, FIG. 5D, and FIGS. 6-21. In an example, the method (including the various aspects detailed below) may be performed by the split-compute compiler 1404 and/or the developer computing device 1502.

At 2702, the apparatus (e.g., the developer computing device 1502) obtains source code for an application. For example, FIG. 20 at 2008 shows that the developer computing device 2006 may obtain source code for an application. In an example, the source code may be or include the application source code 1410. In an example, 2702 may be performed by the split-compute compiler 1404 and/or the developer computing device 1502.

At 2704, the apparatus (e.g., the developer computing device 1502) decomposes the source code into a first set of application functions associated with a UE and a second set of application functions associated with a computing device that is different from the UE, where at least one of the first set of application functions or the second set of application functions are associated with a quality of a link between the UE and the computing device. For example, FIG. 20 at 2010 shows that the developer computing device 2006 may decompose the source code into a first set of application functions associated with the UE 2002 and a second set of application functions associated with the server 2004. In an example, 2704 may be performed by the split-compute compiler 1404 and/or the developer computing device 1502.

At 2706, the apparatus (e.g., the developer computing device 1502) generates a first executable for the UE based on the first set of application functions and a second executable for the computing device based on the second set of application functions. For example, FIG. 20 at 2012 shows that the developer computing device 2006 may generate a first executable for the UE 2002 based on the first set of application functions and a second executable for the server 2004 based on the second set of application functions. In an example, 2706 may be performed by the split-compute compiler 1404 and/or the developer computing device 1502.

At 2708, the apparatus (e.g., the developer computing device 1502) provides the first executable for the UE and the second executable for the computing device. For example, FIG. 20 at 2014 shows that the developer computing device 2006 may provide the first executable for the UE 2002 and FIG. 20 at 2016 shows that the developer computing device 2006 may provide the second executable for the server 2004. In an example, 2708 may be performed by the split-compute compiler 1404 and/or the developer computing device 1502.

In one aspect, at 2710, the first executable for the application may indicate that the UE is to estimate the quality of the link between the UE and the computing device and select a split-compute configuration between the first set of application functions and the second set of application functions based on the quality of the link. The aforementioned aspect may correspond to one or more of the aspects described above in the description of FIG. 22, FIG. 23A, FIG. 23B, FIG. 23C, FIG. 24, FIG. 25A, and/or FIG. 25B.

In one aspect, at 2712, the second executable for the application may indicate that the at least one server is to estimate the quality of the link between the UE and the computing device and select a split-compute configuration between the first set of application functions and the second set of application functions based on the quality of the link. The aforementioned aspect may correspond to one or more of the aspects described above in the description of FIG. 22, FIG. 23A, FIG. 23B, FIG. 23C, FIG. 24, FIG. 25A, and/or FIG. 25B.

In one aspect, the first executable for the application may indicate that the UE is to estimate the quality of the link between the UE and the computing device, transmit, for the computing device, an indication of the estimated quality of the link, and receive, from the computing device and based on the indication of the estimated quality of the link, a split-compute configuration between the first set of application functions and the second set of application functions, and the second executable for the application may indicate that the computing device is to select, based on the indication of the estimated quality of the link, the split-compute configuration and transmit, for the UE, the split-compute configuration. The aforementioned aspect may correspond to one or more of the aspects described above in the description of FIG. 22, FIG. 23A, FIG. 23B, FIG. 23C, FIG. 24, FIG. 25A, and/or FIG. 25B.

In one aspect, the first executable for the application may indicate that the UE is to receive, from the computing device, an indication of an estimated quality of the link and select, based on the indication of the estimated quality of the link, a split-compute configuration between the first set of application functions and the second set of application functions, and the second executable for the application may indicate that the computing device is to estimate the quality of the link between the UE and the computing device and transmit, for the UE, the indication of the estimated quality of the link. The aforementioned aspect may correspond to one or more of the aspects described above in the description of FIG. 22, FIG. 23A, FIG. 23B, FIG. 23C, FIG. 24, FIG. 25A, and/or FIG. 25B.

In one aspect, the quality of the link may be associated with a first split-compute configuration between the first set of application functions and the second set of application functions, where the first executable for the application may indicate that the UE is to receive an indication of an updated quality of the link between the UE and the computing device and that the UE is to select a second split-compute configuration between the first set of application functions and the second set of application functions based on the indication of the updated quality of the link between the UE and the computing device. The aforementioned aspect may correspond to one or more of the aspects described above in the description of FIG. 22, FIG. 23A, FIG. 23B, FIG. 23C, FIG. 24, FIG. 25A, and/or FIG. 25B.

In one aspect, the first executable for the application may indicate that the UE is to determine a corresponding quality of the link for each of a set of split-compute configurations including the split-compute configuration, and the first executable may further indicate that the split-compute configuration is to be selected further based on the corresponding quality of the link for each of the set of split-compute configurations. The aforementioned aspect may correspond to one or more of the aspects described above in the description of FIG. 22, FIG. 23A, FIG. 23B, FIG. 23C, FIG. 24, FIG. 25A, and/or FIG. 25B.

In one aspect, the first executable for the application may indicate that the UE is to estimate the quality of the link between the UE and the computing device based on one or more of: power consumed by the UE during execution of the application, a set of power consumption characteristics of at least one of a transceiver or an antenna of the UE, a time period to understand a channel associated with the link, a current channel capacity associated with the link, or a future channel capacity associated with the link. The aforementioned aspect may correspond to one or more of the aspects described above in the description of FIG. 22, FIG. 23A, FIG. 23B, FIG. 23C, FIG. 24, FIG. 25A, and/or FIG. 25B.

In one aspect, the link may include at least one of a RAN link or a WLAN link. The aforementioned aspect may correspond to one or more of the aspects described above in the description of FIG. 22, FIG. 23A, FIG. 23B, FIG. 23C, FIG. 24, FIG. 25A, and/or FIG. 25B.

In one aspect, the first executable for the application may indicate that the UE is to identify a set of performance metrics associated with the application, and the first executable for the application may indicate that the UE is to select a split-compute configuration further based on the set of performance metrics. The aforementioned aspect may correspond to one or more of the aspects described above in the description of FIG. 22, FIG. 23A, FIG. 23B, FIG. 23C, FIG. 24, FIG. 25A, and/or FIG. 25B.

In one aspect, the first executable for the application may indicate that the UE is to select the split-compute configuration to maintain the set of performance metrics while minimizing a power consumption. The aforementioned aspect may correspond to one or more of the aspects described above in the description of FIG. 22, FIG. 23A, FIG. 23B, FIG. 23C, FIG. 24, FIG. 25A, and/or FIG. 25B.

In one aspect, the set of performance metrics may include at least one of a frame rate of the application, a display resolution of the application, or an operational state of the application. The aforementioned aspect may correspond to one or more of the aspects described above in the description of FIG. 22, FIG. 23A, FIG. 23B, FIG. 23C, FIG. 24, FIG. 25A, and/or FIG. 25B.

In one aspect, the first executable for the application may indicate that the UE is to estimate, at a first time instance, a future quality of the link at a second time instance after the first time instance, and the first executable for the application may indicate that the UE is to select a split-compute configuration further based on the future quality of the link at the second time instance. The aforementioned aspect may correspond to one or more of the aspects described above in the description of FIG. 22, FIG. 23A, FIG. 23B, FIG. 23C, FIG. 24, FIG. 25A, and/or FIG. 25B.

In one aspect, the first executable for the application may indicate that the UE is to estimate, at the first time instance, a confidence level associated with the future quality of the link at the second time instance, and the first executable for the application may indicate that the UE is to select the split-compute configuration further based on the confidence level. The aforementioned aspect may correspond to one or more of the aspects described above in the description of FIG. 22, FIG. 23A, FIG. 23B, FIG. 23C, FIG. 24, FIG. 25A, and/or FIG. 25B.

In one aspect, the UE may include a first type of graphics processor and the at least one server may include a second type of graphics processor, where at least one performance attribute of the second type of graphics processor is greater than the first type of graphics processor. The aforementioned aspect may correspond to one or more of the aspects described above in the description of FIG. 22, FIG. 23A, FIG. 23B, FIG. 23C, FIG. 24, FIG. 25A, and/or FIG. 25B.

In one aspect, the first set of application functions may include at least one of a first game engine, first media codecs, first metadata, or first game state transfer information between the UE and the computing device, and the second set of application functions may include at least one of a second game engine, second media codes, second metadata, and second game state transfer information between the computing device and the UE. The aforementioned aspect may correspond to one or more of the aspects described above in the description of FIG. 22, FIG. 23A, FIG. 23B, FIG. 23C, FIG. 24, FIG. 25A, and/or FIG. 25B.

In configurations, a method or an apparatus for graphics processing is provided. The apparatus may be a GPU, a CPU, or some other processor that may perform graphics processing. In aspects, the apparatus may be the processing unit 120 within the device 104, or may be some other hardware within the device 104 or another device. The apparatus may include means for obtaining an executable for an application including a first set of application functions associated with the UE and a second set of application functions associated with a computing device that is different from the UE. The apparatus may further include means for obtaining an estimated quality of a link between the UE and the computing device. The apparatus may further include means for obtaining, based on the estimated quality of the link, a split-compute configuration between the first set of application functions and the second set of application functions. The apparatus may further include means for outputting an indication of the split-compute configuration. The apparatus may further include means for executing the executable for the application based on the split-compute configuration. The apparatus may further include means for receiving, from the computing device, an indication of an updated quality of the link between the UE and the computing device. The apparatus may further include means for selecting, based on the indication of the updated quality of the link between the UE and the computing device, a second split-compute configuration between the first set of application functions and the second set of application functions. The apparatus may further include means for determining a corresponding quality of the link for each of a set of split-compute configurations including the split-compute configuration, where the split-compute configuration is obtained further based on the corresponding quality of the link for each of the set of split-compute configurations. The apparatus may further include means for identifying a set of performance metrics associated with the application, where the split-compute configuration is obtained further based on the set of performance metrics. The apparatus may further include means for estimating, at a first time instance, a future quality of the link at a second time instance after the first time instance, where the split-compute configuration is obtained further based on the future quality of the link at the second time instance. The apparatus may further include means for estimating, at the first time instance, a confidence level of the future quality of the link at the second time instance after the first time instance, where the split-compute configuration is obtained further based on the confidence level of the future quality of the link at the second time instance. The apparatus may further include means for determining, based on the split-compute configuration, that server-rendered media is to be utilized by the application. The apparatus may further include means for transmitting, to the computing device, a request for the server-rendered media. The apparatus may further include means for receiving, from the computing device and based on the request, the server-rendered media. The apparatus may further include means for computing UE-rendered media associated with the application. The apparatus may further include means for receiving, from the computing device, server-rendered media. The apparatus may further include means for selecting one of the UE-rendered media or the server-rendered media based on a swapchain. The apparatus may further include means for determining an updated quality of the link between the UE and the computing device. The apparatus may further include means for transmitting, for the computing device and based on the updated quality of the link, a first indication that indicates that the computing device is to select a second split-compute configuration or that the computing device is to rate-adapt first information associated with the application. The apparatus may further include means for establishing a session with an application server for the application. The apparatus may further include means for obtaining, from the application server and during the session, at least one of state information for the application or media information for the application. The apparatus may further include means for synchronizing with the computing device based on at least one of the state information for the application or the media information for the application. The apparatus may further include means for receiving, from the computing device, a first indication that indicates that the UE is to select a second split-compute configuration or that the UE is to rate-adapt first information associated with the application. The apparatus may further include means for displaying a frame generated based on the split-compute configuration.

In configurations, a method or an apparatus for graphics processing is provided. The apparatus may be a GPU, a CPU, or some other processor that may perform graphics processing. In aspects, the apparatus may be the edge 1518, or may be some other hardware within the edge 1518 or another device. The apparatus may include means for obtaining an executable for an application including a first set of application functions associated with a user equipment (UE) and a second set of application functions associated with the server. The apparatus may further include means for obtaining an estimated quality of a link between the UE and the server. The apparatus may include means for obtaining, based on the estimated quality of the link, a split-compute configuration between the first set of application functions and the second set of application functions. The apparatus may include means for outputting an indication of the split-compute configuration. The apparatus may include means for executing the executable for the application based on the split-compute configuration. The apparatus may include means for determining an updated quality of the link between the UE and the server. The apparatus may include means for transmitting, for the UE, an indication of the updated quality of the link between the UE and the server. The apparatus may include means for obtaining, based on the indication of the updated quality of the link between the UE and the server, a second split-compute configuration between the first set of application functions and the second set of application functions. The apparatus may include means for identifying a set of performance metrics associated with the application, where the split-compute configuration is obtained further based on the set of performance metrics. The apparatus may include means for estimating, at a first time instance, a future quality of the link at a second time instance after the first time instance, where the split-compute configuration is obtained further based on the future quality of the link at the second time instance. The apparatus may include means for estimating, at the first time instance, a confidence level of the future quality of the link at the second time instance after the first time instance, where the split-compute configuration is obtained further based on the confidence level of the future quality of the link at the second time instance. The apparatus may include means for transmitting, for the UE, server-rendered media. The apparatus may include means for receiving, from the UE, a request for the server-rendered media, where the server-rendered media is transmitted for the UE based on the request. The apparatus may include means for determining an updated quality of the link between the UE and the server. The apparatus may include means for transmitting, for the UE and based on the updated quality of the link, a first indication that indicates that the UE is to select a second split-compute configuration or that the UE is to rate-adapt first information associated with the application. The apparatus may include means for establishing a session with an application server for the application. The apparatus may include means for obtaining, from the application server and during the session, at least one of state information for the application or media information for the application. The apparatus may include means for synchronizing with the UE based on at least one of the state information for the application or the media information for the application. The apparatus may include means for receiving, from the UE, a first indication that indicates that the server is to select a second split-compute configuration or that the server is to rate-adapt first information associated with the application.

In configurations, a method or an apparatus for graphics processing is provided. The apparatus may be a GPU, a CPU, or some other processor that may perform graphics processing. In aspects, the apparatus may be the developer computing device 1502, or may be some other hardware within the developer computing device 1502 or another device. The apparatus may include means for obtaining source code for an application. The apparatus may further include means for decomposing the source code into a first set of application functions associated with a user equipment (UE) and a second set of application functions associated with a computing device that is different from the UE, where at least one of the first set of application functions or the second set of application functions are associated with a quality of a link between the UE and the computing device. The apparatus may further include means for generating a first executable for the UE based on the first set of application functions and a second executable for the computing device based on the second set of application functions. The apparatus may further include means for providing the first executable for the UE and the second executable for the computing device.

It is understood that the specific order or hierarchy of blocks/steps in the processes, flowcharts, and/or call flow diagrams disclosed herein is an illustration of example approaches. Based upon design preferences, it is understood that the specific order or hierarchy of the blocks/steps in the processes, flowcharts, and/or call flow diagrams may be rearranged. Further, some blocks/steps may be combined and/or omitted. Other blocks/steps may also be added. The accompanying method claims present elements of the various blocks/steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, where reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.” Unless stated otherwise, the phrase “a processor” may refer to “any of one or more processors” (e.g., one processor of one or more processors, a number (greater than one) of processors in the one or more processors, or all of the one or more processors) and the phrase “a memory” may refer to “any of one or more memories” (e.g., one memory of one or more memories, a number (greater than one) of memories in the one or more memories, or all of the one or more memories).

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

Computer-readable media may include computer data storage media or communication media including any medium that facilitates transfer of a computer program from one place to another. In this manner, computer-readable media generally may correspond to: (1) tangible computer-readable storage media, which is non-transitory; or (2) a communication medium such as a signal or carrier wave. Data storage media may be any available media that can be accessed by one or more computers or one or more processors to retrieve instructions, code, and/or data structures for implementation of the techniques described in this disclosure. By way of example, and not limitation, such computer-readable media may include RAM, ROM, EEPROM, compact disc-read only memory (CD-ROM), or other optical disk storage, magnetic disk storage, or other magnetic storage devices. Disk and disc, as used herein, includes compact disc (CD), laser disc, optical disc, digital versatile disc (DVD), floppy disk, and Blu-ray disc, where disks usually reproduce data magnetically, while discs usually reproduce data optically with lasers. Combinations of the above should also be included within the scope of computer-readable media. A computer program product may include a computer-readable medium.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 is a method of graphics processing at a user equipment (UE), including: obtaining an executable for an application including a first set of application functions associated with the UE and a second set of application functions associated with a computing device that is different from the UE; obtaining an estimated quality of a link between the UE and the computing device; obtaining, based on the estimated quality of the link, a split-compute configuration between the first set of application functions and the second set of application functions; and outputting an indication of the split-compute configuration.

Aspect 2 may be combined with aspect 1 and includes that obtaining the estimated quality of the link includes estimating a quality of the link between the UE and the computing device, and where obtaining the split-compute configuration includes selecting, based on the estimated quality of the link, the split-compute configuration.

Aspect 3 may be combined with aspect 1 and includes that obtaining the estimated quality of the link includes receiving, from the computing device, an indication of the estimated quality of the link, and where obtaining the split-compute configuration includes selecting, based on the indication of the estimated quality of the link, the split-compute configuration.

Aspect 4 may be combined with aspect 1 and includes that obtaining the estimated quality of the link includes estimating a quality of the link between the UE and the computing device, and where obtaining the split-compute configuration includes: transmitting, for the computing device, an indication of the estimated quality of the link; and receiving, from the computing device and based on the indication of the estimated quality of the link, the split-compute configuration.

Aspect 5 may be combined with any of aspects 1-4 and further includes executing the executable for the application based on the split-compute configuration.

Aspect 6 may be combined with any of aspects 1-5 and further includes receiving, from the computing device, an indication of an updated quality of the link between the UE and the computing device; and selecting, based on the indication of the updated quality of the link between the UE and the computing device, a second split-compute configuration between the first set of application functions and the second set of application functions.

Aspect 7 may be combined with any of aspects 1-6 and further includes determining a corresponding quality of the link for each of a set of split-compute configurations including the split-compute configuration, where the split-compute configuration is obtained further based on the corresponding quality of the link for each of the set of split-compute configurations.

Aspect 8 may be combined with any of aspects 1-7 and includes that the estimated quality of the link between the UE and the computing device is based on: power consumed by the UE during execution of the application, a set of power consumption characteristics of at least one of a transceiver or an antenna of the UE, a time period to understand a channel associated with the link, a current channel capacity associated with the link, or a future channel capacity associated with the link.

Aspect 9 may be combined with any of aspects 1-8 and includes that the link includes at least one of a radio access network (RAN) link or a wireless local area network (WLAN) link.

Aspect 10 may be combined with any of aspects 1-9 and further includes identifying a set of performance metrics associated with the application, where the split-compute configuration is obtained further based on the set of performance metrics.

Aspect 11 may be combined with aspect 10 and includes that the split-compute configuration maintains the set of performance metrics while minimizing a power consumption of the UE.

Aspect 12 may be combined with aspect 11 and includes that the set of performance metrics includes at least one of a frame rate of the application, a display resolution of the application, or an operational state of the application.

Aspect 13 may be combined with any of aspects 1-12 and further includes estimating, at a first time instance, a future quality of the link at a second time instance after the first time instance, where the split-compute configuration is obtained further based on the future quality of the link at the second time instance.

Aspect 14 may be combined with aspect 13 and further includes estimating, at the first time instance, a confidence level of the future quality of the link at the second time instance after the first time instance, where the split-compute configuration is obtained further based on the confidence level of the future quality of the link at the second time instance.

Aspect 15 may be combined with any of aspects 1-14 and includes that outputting the indication of the split-compute configuration includes at least one of: transmitting the indication of the split-compute configuration to the computing device or storing the indication of the split-compute configuration in at least one of a memory or a cache.

Aspect 16 may be combined with any of aspects 1-15 and includes that the indication of the split-compute configuration is transmitted to the computing device, the method further including: determining, based on the split-compute configuration, that server-rendered media is to be utilized by the application; transmitting, to the computing device, a request for the server-rendered media; and receiving, from the computing device and based on the request, the server-rendered media.

Aspect 17 may be combined with any of aspects 1-15 and includes that the indication of the split-compute configuration is transmitted to the computing device, the method further including: computing UE-rendered media associated with the application; receiving, from the computing device, server-rendered media; and selecting one of the UE-rendered media or the server-rendered media based on a swapchain.

Aspect 18 may be combined with any of aspects 1-17 and includes that the UE includes a first type of graphics processor and the computing device includes a second type of graphics processor, where at least one performance attribute of the second type of graphics processor is greater than the first type of graphics processor.

Aspect 19 may be combined with any of aspects 1-18 and includes that the first set of application functions includes at least one of a first game engine, first media codecs, first metadata, or first game state transfer information between the UE and the computing device, and where the second set of application functions includes at least one of a second game engine, second media codes, second metadata, and second game state transfer information between the computing device and the UE.

Aspect 20 may be combined with any of aspects 1-19 and further includes determining an updated quality of the link between the UE and the computing device; and transmitting, for the computing device and based on the updated quality of the link, a first indication that indicates that the computing device is to select a second split-compute configuration or that the computing device is to rate-adapt first information associated with the application.

Aspect 21 may be combined with any of aspects 1-20 and further includes establishing a session with an application server for the application; obtaining, from the application server and during the session, at least one of state information for the application or media information for the application; and synchronizing with the computing device based on at least one of the state information for the application or the media information for the application.

Aspect 22 may be combined with any of aspects 1-21 and further includes receiving, from the computing device, a first indication that indicates that the UE is to select a second split-compute configuration or that the UE is to rate-adapt first information associated with the application.

Aspect 23 may be combined with any of aspects 1-22 and further includes displaying a frame generated based on the split-compute configuration.

Aspect 24 may be combined with any of aspects 1-23 and includes that the computing device includes at least one server.

Aspect 25 is an apparatus for graphics processing including a processor coupled to a memory, and based on information stored in the memory, the processor is configured to implement a method as in any of aspects 1-24.

Aspect 26 may be combined with aspect 25 and includes that the apparatus is a wireless communication device including at least one of a transceiver or an antenna coupled to the processor, where the processor is configured to output the indication of the split-compute configuration via at least one of the transceiver or the antenna.

Aspect 27 is an apparatus for graphics processing including means for implementing a method as in any of aspects 1-24.

Aspect 28 is a computer-readable medium (e.g., a non-transitory computer-readable medium) storing computer executable code, the computer executable code when executed by a processor causes the processor to implement a method as in any of aspects 1-24.

Aspect 29 is a method of graphics processing, including: obtaining source code for an application; decomposing the source code into a first set of application functions associated with a user equipment (UE) and a second set of application functions associated with a computing device, where at least one of the first set of application functions or the second set of application functions are associated with a quality of a link between the UE and the computing device; generating a first executable for the UE based on the first set of application functions and a second executable for the computing device based on the second set of application functions; and providing the first executable for the UE and the second executable for the computing device.

Aspect 30 may be combined with aspect 29 and includes that the first executable for the application indicates that the UE is to estimate the quality of the link between the UE and the computing device and select a split-compute configuration between the first set of application functions and the second set of application functions based on the quality of the link.

Aspect 31 may be combined with aspect 29 and includes that the second executable for the application indicates that the computing device is to estimate the quality of the link between the UE and the computing device and select a split-compute configuration between the first set of application functions and the second set of application functions based on the quality of the link.

Aspect 32 may be combined with aspect 29 and includes that the first executable for the application indicates that the UE is to estimate the quality of the link between the UE and the computing device, transmit, for the computing device, an indication of the estimated quality of the link, and receive, from the computing device and based on the indication of the estimated quality of the link, a split-compute configuration between the first set of application functions and the second set of application functions, and where the second executable for the application indicates that the computing device is to select, based on the indication of the estimated quality of the link, the split-compute configuration and transmit, for the UE, the split-compute configuration.

Aspect 33 may be combined with any of aspects 29-32 and includes that the first executable for the application indicates that the UE is to receive, from the computing device, an indication of an estimated quality of the link and select, based on the indication of the estimated quality of the link, a split-compute configuration between the first set of application functions and the second set of application functions, and where the second executable for the application indicates that the computing device is to estimate the quality of the link between the UE and the computing device and transmit, for the UE, the indication of the estimated quality of the link.

Aspect 34 may be combined with any of aspects 29-33 and includes that the quality of the link is associated with a first split-compute configuration between the first set of application functions and the second set of application functions, where the first executable for the application indicates that the UE is to receive an indication of an updated quality of the link between the UE and the computing device and that the UE is to select a second split-compute configuration between the first set of application functions and the second set of application functions based on the indication of the updated quality of the link between the UE and the computing device.

Aspect 35 may be combined with any of aspects 29-34 and includes that the first executable for the application indicates that the UE is to determine a corresponding quality of the link for each of a set of split-compute configurations, and where the first executable further indicates that a split-compute configuration is to be selected based on the corresponding quality of the link for each of the set of split-compute configurations.

Aspect 36 may be combined with any of aspects 29-35 and includes that the first executable for the application indicates that the UE is to estimate the quality of the link between the UE and the computing device based on one or more of: power consumed by the UE during execution of the application, a set of power consumption characteristics of at least one of a transceiver or an antenna of the UE, a time period to understand a channel associated with the link, a current channel capacity associated with the link, or a future channel capacity associated with the link.

Aspect 37 may be combined with any of aspects 29-36 and includes that the link includes at least one of a radio access network (RAN) link or a wireless local area network (WLAN) link.

Aspect 38 may be combined with any of aspects 29-37 and includes that the first executable for the application indicates that the UE is to identify a set of performance metrics associated with the application, and where the first executable for the application indicates that the UE is to select a split-compute configuration further based on the set of performance metrics.

Aspect 39 may be combined with aspect 38 and includes that the first executable for the application indicates that the UE is to select the split-compute configuration to maintain the set of performance metrics while minimizing a power consumption.

Aspect 40 may be combined with aspect 39 and includes that the set of performance metrics includes at least one of a frame rate of the application, a display resolution of the application, or an operational state of the application.

Aspect 41 may be combined with any of aspects 29-40 and includes that the first executable for the application indicates that the UE is to estimate, at a first time instance, a future quality of the link at a second time instance after the first time instance, and where the first executable for the application indicates that the UE is to select a split-compute configuration further based on the future quality of the link at the second time instance.

Aspect 42 may be combined with aspect 41 and includes that the first executable for the application indicates that the UE is to estimate, at the first time instance, a confidence level associated with the future quality of the link at the second time instance, and where the first executable for the application indicates that the UE is to select the split-compute configuration further based on the confidence level.

Aspect 43 may be combined with any of aspects 29-42 and includes that the UE includes a first type of graphics processor and the computing device includes a second type of graphics processor, where at least one performance attribute of the second type of graphics processor is greater than the first type of graphics processor.

Aspect 44 may be combined with any of aspects 29-43 and includes that the first set of application functions includes at least one of a first game engine, first media codecs, first metadata, or first game state transfer information between the UE and the computing device, and where the second set of application functions includes at least one of a second game engine, second media codes, second metadata, and second game state transfer information between the computing device and the UE.

Aspect 45 is an apparatus for graphics processing including a processor coupled to a memory and, based on information stored in the memory, the processor is configured to implement a method as in any of aspects 29-44.

Aspect 46 may be combined with aspect 45 and includes that the apparatus is a wireless communication device including at least one of a transceiver or an antenna coupled to the processor, where the processor is configured to provide the first executable for the UE and the second executable for the computing device via at least one of the transceiver or the antenna.

Aspect 47 is an apparatus for graphics processing including means for implementing a method as in any of aspects 29-44.

Aspect 48 is a computer-readable medium (e.g., a non-transitory computer-readable medium) storing computer executable code, the computer executable code when executed by a processor causes the processor to implement a method as in any of aspects 29-44.

Aspect 49 is a method of graphics processing at a server, including: obtaining an executable for an application including a first set of application functions associated with a user equipment (UE) and a second set of application functions associated with the server; obtaining an estimated quality of a link between the UE and the server; obtaining, based on the estimated quality of the link, a split-compute configuration between the first set of application functions and the second set of application functions; and outputting an indication of the split-compute configuration.

Aspect 50 may be combined with aspect 49 and includes that obtaining the estimated quality of the link includes estimating a quality of the link between the UE and the server, and where obtaining the split-compute configuration includes selecting, based on the estimated quality of the link, the split-compute configuration.

Aspect 51 may be combined with aspect 49 and includes that obtaining the estimated quality of the link includes receiving, from the UE, an indication of the estimated quality of the link, and where obtaining the split-compute configuration includes selecting, based on the indication of the estimated quality of the link, the split-compute configuration.

Aspect 52 may be combined with aspect 49 and includes that obtaining the estimated quality of the link includes estimating a quality of the link between the UE and the server, and where obtaining the split-compute configuration includes: transmitting, for the UE, an indication of the estimated quality of the link; and receiving, from the UE and based on the indication of the estimated quality of the link, the split-compute configuration.

Aspect 53 may be combined with any of aspects 49-52 and further includes executing the executable for the application based on the split-compute configuration.

Aspect 54 may be combined with any of aspects 49-53 and further includes determining an updated quality of the link between the UE and the server; transmitting, for the UE, an indication of the updated quality of the link between the UE and the server; and obtaining, based on the indication of the updated quality of the link between the UE and the server, a second split-compute configuration between the first set of application functions and the second set of application functions.

Aspect 55 may be combined with any of aspects 49-54 and includes that the link includes at least one of a radio access network (RAN) link or a wireless local area network (WLAN) link.

Aspect 56 may be combined with any of aspects 49-55 and further includes identifying a set of performance metrics associated with the application, where the split-compute configuration is obtained further based on the set of performance metrics.

Aspect 57 may be combined with aspect 56 and includes that the split-compute configuration maintains the set of performance metrics while minimizing a power consumption of the UE.

Aspect 58 may be combined with aspect 57 and includes that the set of performance metrics includes at least one of a frame rate of the application, a display resolution of the application, or an operational state of the application.

Aspect 59 may be combined with any of aspects 49-58 and further includes estimating, at a first time instance, a future quality of the link at a second time instance after the first time instance, where the split-compute configuration is obtained further based on the future quality of the link at the second time instance.

Aspect 60 may be combined with any of aspects 49-59 and further includes estimating, at the first time instance, a confidence level of the future quality of the link at the second time instance after the first time instance, where the split-compute configuration is obtained further based on the confidence level of the future quality of the link at the second time instance.

Aspect 61 may be combined with any of aspects 49-60 and includes that outputting the indication of the split-compute configuration includes at least one of: transmitting the indication of the split-compute configuration to the UE or storing the indication of the split-compute configuration in at least one of a memory or a cache.

Aspect 62 may be combined with aspect 61 and includes that the indication of the split-compute configuration is received from the UE, the method further including: transmitting, for the UE, server-rendered media.

Aspect 63 may be combined with aspect 62 and further includes receiving, from the UE, a request for the server-rendered media, where the server-rendered media is transmitted for the UE based on the request.

Aspect 64 may be combined with any of aspects 49-63 and includes that the UE includes a first type of graphics processor and the server includes a second type of graphics processor, where at least one performance attribute of the second type of graphics processor is greater than the first type of graphics processor.

Aspect 65 may be combined with any of aspects 49-64 and includes that the first set of application functions includes at least one of a first game engine, first media codecs, first metadata, or first game state transfer information between the UE and the server, and where the second set of application functions includes at least one of a second game engine, second media codes, second metadata, and second game state transfer information between the server and the UE.

Aspect 66 may be combined with any of aspects 49-65 and further includes determining an updated quality of the link between the UE and the server; and transmitting, for the UE and based on the updated quality of the link, a first indication that indicates that the UE is to select a second split-compute configuration or that the UE is to rate-adapt first information associated with the application.

Aspect 67 may be combined with any of aspects 49-66 and further includes establishing a session with an application server for the application; obtaining, from the application server and during the session, at least one of state information for the application or media information for the application; and synchronizing with the UE based on at least one of the state information for the application or the media information for the application.

Aspect 68 may be combined with any of aspects 49-67 and further includes receiving, from the UE, a first indication that indicates that the server is to select a second split-compute configuration or that the server is to rate-adapt first information associated with the application.

Aspect 69 is an apparatus for graphics processing including a processor coupled to a memory and, based on information stored in the memory, the processor is configured to implement a method as in any of aspects 49-68.

Aspect 70 may be combined with aspect 69 and includes that the apparatus is a wireless communication device including at least one of a transceiver or an antenna coupled to the processor, where the processor is configured to output the indication of the split-compute configuration via at least one of the transceiver or the antenna.

Aspect 71 is an apparatus for graphics processing including means for implementing a method as in any of aspects 49-68.

Aspect 72 is a computer-readable medium (e.g., a non-transitory computer-readable medium) storing computer executable code, the computer executable code when executed by a processor causes the processor to implement a method as in any of aspects 49-68.

Various aspects have been described herein. These and other aspects are within the scope of the following claims.

What is claimed is:

1. An apparatus for graphics processing at a user equipment (UE), comprising:
a memory; and
a processor coupled to the memory and, based on information stored in the memory, the processor is configured to:
obtain an executable for an application including a first set of application functions associated with the UE and a second set of application functions associated with a computing device that is different from the UE;
obtain an estimated quality of a link between the UE and the computing device;
obtain, based on the estimated quality of the link, a split-compute configuration between the first set of application functions and the second set of application functions; and
output an indication of the split-compute configuration.

2. The apparatus of claim 1, wherein to obtain the estimated quality of the link, the processor is configured to estimate a quality of the link between the UE and the computing device, and wherein to obtain the split-compute configuration, the processor is configured to select, based on the estimated quality of the link, the split-compute configuration.

3. The apparatus of claim 1, wherein to obtain the estimated quality of the link, the processor is configured to receive, from the computing device, an indication of the estimated quality of the link, and wherein to obtain the split-compute configuration, the processor is configured to select, based on the indication of the estimated quality of the link, the split-compute configuration.

4. The apparatus of claim 1, wherein to obtain the estimated quality of the link, the processor is configured to estimate a quality of the link between the UE and the computing device, and wherein to obtain the split-compute configuration, the processor is configured to:
transmit, for the computing device, an indication of the estimated quality of the link; and
receive, from the computing device and based on the indication of the estimated quality of the link, the split-compute configuration.

5. The apparatus of claim 1, wherein the processor is further configured to:
execute the executable for the application based on the split-compute configuration.

6. The apparatus of claim 1, wherein the processor is further configured to:
receive, from the computing device, an indication of an updated quality of the link between the UE and the computing device; and
select, based on the indication of the updated quality of the link between the UE and the computing device, a second split-compute configuration between the first set of application functions and the second set of application functions.

7. The apparatus of claim 1, wherein the processor is further configured to:
determine a corresponding quality of the link for each of a set of split-compute configurations including the split-compute configuration, wherein to obtain the split-compute configuration, the processor is configured to obtain the split-compute configuration further based on the corresponding quality of the link for each of the set of split-compute configurations.

8. The apparatus of claim 1, wherein the estimated quality of the link between the UE and the computing device is based on: power consumed by the UE during execution of the application, a set of power consumption characteristics of at least one of a transceiver or an antenna of the UE, a time period to understand a channel associated with the link, a current channel capacity associated with the link, or a future channel capacity associated with the link.

9. The apparatus of claim 1, wherein the link comprises at least one of a radio access network (RAN) link or a wireless local area network (WLAN) link.

10. The apparatus of claim 1, wherein the processor is further configured to:
identify a set of performance metrics associated with the application, wherein to obtain the split-compute configuration, the processor is configured to obtain the split-compute configuration further based on the set of performance metrics.

11. The apparatus of claim 10, wherein the split-compute configuration maintains the set of performance metrics while minimizing a power consumption of the UE.

12. The apparatus of claim 11, wherein the set of performance metrics comprises at least one of a frame rate of the application, a display resolution of the application, or an operational state of the application.

13. The apparatus of claim 1, wherein the processor is further configured to:
estimate, at a first time instance, a future quality of the link at a second time instance after the first time instance, wherein to obtain the split-compute configuration, the processor is configured to obtain the split-compute configuration further based on the future quality of the link at the second time instance.

14. The apparatus of claim 13, wherein the processor is further configured to:
estimate, at the first time instance, a confidence level of the future quality of the link at the second time instance after the first time instance, wherein to obtain the split-compute configuration, the processor is configured to obtain the split-compute configuration further based on the confidence level of the future quality of the link at the second time instance.

15. The apparatus of claim 1, wherein to output the indication of the split-compute configuration, the processor is configured to: transmit the indication of the split-compute configuration to the computing device or store the indication of the split-compute configuration in at least one of the memory or a cache.

16. The apparatus of claim 15, wherein the processor is configured to transmit the indication of the split-compute configuration to the computing device, and wherein the processor is further configured to:
determine, based on the split-compute configuration, that server-rendered media is to be utilized by the application;
transmit, to the computing device, a request for the server-rendered media; and
receive, from the computing device and based on the request, the server-rendered media.

17. The apparatus of claim 15, wherein the processor is configured to transmit the indication of the split-compute configuration to the computing device, and wherein the processor is further configured to:
compute UE-rendered media associated with the application;
receive, from the computing device, server-rendered media; and
select one of the UE-rendered media or the server-rendered media based on a swapchain.

18. The apparatus of claim 1, wherein the UE includes a first type of graphics processor and the computing device includes a second type of graphics processor, wherein at least one performance attribute of the second type of graphics processor is greater than the first type of graphics processor.

19. The apparatus of claim 1, wherein the first set of application functions includes at least one of a first game engine, first media codecs, first metadata, or first game state transfer information between the UE and the computing device, and wherein the second set of application functions includes at least one of a second game engine, second media codes, second metadata, and second game state transfer information between the computing device and the UE.

20. The apparatus of claim 1, wherein the processor is further configured to:
determine an updated quality of the link between the UE and the computing device; and
transmit, for the computing device and based on the updated quality of the link, a first indication that indicates that the computing device is to select a second split-compute configuration or that the computing device is to rate-adapt first information associated with the application.

21. The apparatus of claim 1, wherein the processor is further configured to:
establish a session with an application server for the application;
obtain, from the application server and during the session, at least one of state information for the application or media information for the application; and
synchronize with the computing device based on at least one of the state information for the application or the media information for the application.

22. The apparatus of claim 1, wherein the processor is further configured to:
receive, from the computing device, a first indication that indicates that the UE is to select a second split-compute configuration or that the UE is to rate-adapt first information associated with the application.

23. The apparatus of claim 1, wherein the apparatus is a wireless communications device comprising at least one of a transceiver or an antenna coupled to the processor, and wherein to output the indication of the split-compute configuration, the processor is configured to output the indication of the split-compute configuration via at least one of the transceiver or the antenna.

24. The apparatus of claim 1, wherein the processor is further configured to:
display a frame generated based on the split-compute configuration.

25. The apparatus of claim 1, wherein the computing device comprises at least one server.

26. An apparatus for graphics processing, comprising:
a memory; and
a processor coupled to the memory and, based on information stored in the memory, the processor is configured to:
obtain source code for an application;
decompose the source code into a first set of application functions associated with a user equipment (UE) and a second set of application functions associated with a computing device that is different from the UE, wherein at least one of the first set of application functions or the second set of application functions are associated with a quality of a link between the UE and the computing device;
generate a first executable for the UE based on the first set of application functions and a second executable for the computing device based on the second set of application functions; and
provide the first executable for the UE and the second executable for the computing device.

27. An apparatus for graphics processing at a server, comprising:
a memory; and
a processor coupled to the memory and, based on information stored in the memory, the processor is configured to:
obtain an executable for an application including a first set of application functions associated with a user equipment (UE) and a second set of application functions associated with the server;
obtain an estimated quality of a link between the UE and the server;
obtain, based on the estimated quality of the link, a split-compute configuration between the first set of application functions and the second set of application functions; and
output an indication of the split-compute configuration.

28. The apparatus of claim 27, wherein the apparatus is a wireless communications device comprising at least one of a transceiver or an antenna coupled to the processor, and wherein to output the indication of the split-compute configuration, the processor is configured to output the indication of the split-compute configuration via at least one of the transceiver or the antenna.

29. The apparatus of claim 27, wherein to obtain the estimated quality of the link, the processor is configured to estimate a quality of the link between the UE and the server, and wherein to obtain the split-compute configuration, the processor is configured to select, based on the estimated quality of the link, the split-compute configuration.

30. A method of graphics processing at a user equipment (UE), comprising:
obtaining an executable for an application including a first set of application functions associated with the UE and a second set of application functions associated with a computing device that is different from the UE;
obtaining an estimated quality of a link between the UE and the computing device;
obtaining, based on the estimated quality of the link, a split-compute configuration between the first set of application functions and the second set of application functions; and
outputting an indication of the split-compute configuration.
